(19) United States
(12) Patent Application Publication
(10) Pub. No.: US 2019/0388796 A1
(43) Pub. Date: Dec. 26, 2019

(54) TOY RESERVOIR TO GENERATE FOAM STRING OR THE LIKE

(71) Applicants: Sweet Spot Studio, Inc., Saugatuck, MI (US); Versadyne LLC, Pine Bush, NY (US)

(72) Inventors: Jon Vanderbeek, Saugatuck, MI (US); Philip R. Iehle, Pine Bush, NY (US)

(73) Assignees: Sweet Spot Studio, Inc., Saugatuck, MI (US); Versadyne LLC, Pine Bush, NY (US)

(21) Appl. No.: 16/450,245

(22) Filed: Jun. 24, 2019

Related U.S. Application Data
(60) Provisional application No. 62/689,493, filed on Jun. 25, 2018.

(51) Int. Cl. A63H 3/36; B65D 83/14

(52) U.S. Cl. CPC A63H 3/36; B65D 83/75

(57) ABSTRACT

A toy having a housing for use or integration with handheld toy products such as action figures for string generating foam discharge toy elements capable of projecting string webs or other launched foam discharge, and further methods of charging receptacle reservoir cavities from a canister supply, and projecting foam string or web discharge with activating or triggering action of the toy features associated with mechanical manipulations through the use of valve controls, used with a removable canister containing the discharge element.

### CROSS REFERENCE TO RELATED APPLICATIONS

The present application claims priority to U.S. Provisional Application 62/689,493 filed Jun. 25, 2018, hereby incorporated by reference.

### BACKGROUND OF THE INVENTION

The present invention relates to manipulatable toys and, more precisely, to handheld products which incorporate string generating foam discharge toy elements capable of projecting string webs and/or other foam discharge launched by simply triggering, pressing or rotating an activator or lever one or more times. The invention also relates to methods charging receptacle reservoir cavities from a canister supply, as well as using such for projecting such a discharge though the activating and triggering action of the toy features associated with mechanical manipulations using valve controls, devices and the like providing mechanical manipulations, etc.

Similar to most fields, the toy industry is always striving for the next best thing. Ideas and products need to be fresh and inventive, displaying added features and abilities over their predecessors. Many kinds of shooting toys exist and are designed for the amusement of children and adults alike. Shooting toys come in various shapes with some of the most common toys shaped like guns of all sizes. Various other known shooting devices exist and include configurations which squirt water from reservoirs and discharge numerous projectiles from multiple chambers.

Water guns in the shape of hand guns, rifles, machine guns, and other configurations have been the most common type of toy utilizing water as a projectile. These configurations can be simple hand-held squirt guns that use trigger-activated pumps to eject water, or more complicated and sophisticated shooters that rely upon pressurized tanks to shoot a stream of water a significant distance. Concealed water guns add an extra dimension of fun in water fights and allow a user to move very close to their intended target before shooting the water. As a result, many gun configurations have allowed a user to squirt water from various reservoirs often hidden on the body of the user. Some of these configurations have relied upon an electric pump activated by a switch to eject water from a nozzle, as well as configurations which include a pressurized bladder plumbed to a trigger-operated nozzle mounted on a wrist of a user or worn around a user's waist.

U.S. Pat. No. 3,705,669 to Cox, et al. for “Foamable Resinous Composition” issued Dec. 12, 1972 (“Silly String™” assigned to Wham-0 Manufacturing Co., San Gabriel, Calif.), hereby incorporated into the present disclosure by reference in its entirety, discloses a pressurized or “aerosol” canister containing a composition of matter for producing a string of plastic foam is described. The plastic foam produced from the aerosol can is in the form of a cohesive plastic body sufficiently tacky to adhere to inert surfaces such as walls, windows or the like to support the weight of the foam, however, of insufficient tackiness to adhere with a force greater than the cohesive strength of the foam so that the foamed body can be readily removed from surfaces to which it lightly adheres. Such a combination has substantial play and decorative utility. User toy apparatus for the forgoing pressurized aerosol canister for producing a string of plastic foam are known, e.g., U.S. Pat. No. 5,072,856 to Kimble for “Toy web-shooting glove” issued Dec. 17, 1991 discloses a user-worn glove with a combination of components to produce its toy shooting apparatus, as a toy that makes it possible for users to act like a spider person by shooting webs from the palm of his or her hand. The webbing material consists of string foam delivered from a hidden pressurized container used through a valve incorporated into a glove worn by the player. A trigger mechanism enables the player to activate the valve at will by the exercise of pressure with the fingers of the user's hand wearing the glove.

Hand-held liquid candy dispenser U.S. Pat. No. 6,454,128 to Harris issued Sep. 24, 2002 discloses hand-held structures and toys including liquid candy dispensing generated from toy characters and the like, hereby incorporated into the present disclosure by reference in its entirety; Harris describes a liquid candy dispenser may include a liquid candy reservoir having an internal space formed therein that may contain liquid candy coupled to an insect or bug shaped candy dispensing structure. The reservoir may be sized to fit within a person's hand, and the reservoir may have a liquid candy supply hole. A dispensing structure may have a dispensing hole formed therein and a retaining portion that allows the dispensing structure to be placed and retained on the person's finger. The supply hole and the dispensing hole may be fluidly coupled so that, when the reservoir is squeezed by the person, a portion of liquid candy may be forced from the reservoir through the dispensing hole so that the portion of liquid candy may be tasted by the person. Additionally, various types of dispensers for dispensing liquids have been previously proposed. For example, U.S. Pat. No. 4,061,249 to Smith for “Aerosol Dispensing Ring” issued Dec. 6, 1977 discloses a ring dispenser adapted to be worn on a person's finger having an internal reservoir that is filled with a pressurized irritant intended to be used for self-defense purposes and a flower-shaped portion having a spray hole formed therein. The irritant, which is disclosed as an aerosol, is sprayed from the reservoir through the spray hole to ward off would-be attackers.

U.S. Pat. No. 6,223,744 to Garon for “Wearable aerosol delivery apparatus” issued May 1, 2001 relates to a user wearable medical active ingredient aerosol delivery apparatus for release into an oral or nasal passage, wearable as disposed on a person's wrist with housing defining a reservoir for containing the aerosol under pressure, an aerosol release mechanism connected with the reservoir for releasing a dose of the aerosol from the reservoir when actuated, and a fastener member attached to the housing to fasten the housing onto the user's wrist for delivering the active ingredient on demand. The Garon apparatus has a filling mechanism communicating with the reservoir with its second valve connected to the reservoir for injecting the aerosol therein via a filling inlet disposed through the side surface of its wearable housing. The Garon filling inlet channel and reservoir use conventional one-way valve or spring-activated valves for filling without integration with handheld toy products for string generating foam discharge of foamable resinous composition capable of projecting string webs or other launched foam discharge. Further the Garon focus is a dosing function release valve where the activation valve operates to automatically close for its dosing function, and thus additionally Garon does not address clean-out or handling drying of the product open or access tools to facilitate cleaning of the reservoir cavities to ensure the life of toy structures.

Other known projectile discharge devices include held or worn devices which are capable of shooting numerous projectiles. Some of these devices are shaped like guns employing a variety of discharge ports and a distribution mechanism to conduct the pressurized gas or liquid to the discharge ports to eject solid projectiles or liquid and gas. Other known devices are worn on the back of the hand of the user and employ a plurality of chambers capable of receiving numerous projectiles which are deployed by pulling each one of the multiple triggers linked to each one of the plurality of chambers. As technology continues to improve, consumers want toys that have more capabilities or that are more realistic. Consumer driven evolutions in the industry is found in toys embodied as cars, dolls and various other life forms real or imagined. To provide a more realistic and interactive toy, a cost-technology trade off becomes important. As is known, new technologies cannot typically be implemented to meet customer demands because of other constraints played on the industry by consumers.

Significantly, known shooting toys do not facilitate manipulatable handheld toys which incorporate string generating foam discharge toy elements capable of projecting foam string webs with methods of charging receptacle reservoir cavities in the toy from a canister supply. It would be desirable to provide a mechanism with the triggering action capable of projecting a discharge though the activating and triggering action of the toy features associated with mechanical manipulations using valve controls, devices with toy elements being charged into receptacle or reservoir cavities inside the toy.

### SUMMARY OF THE INVENTION

The present invention addresses shortcomings of the prior art to provide a toy capable of projecting a discharge element from a variety of string, foam, web or fluid discharge embodiments for firing through child toy activation with an actuator at the toy manipulated by the user.

Briefly summarized, the present invention relates to a toy having a housing with valve components to receive a contained discharge element, and an actuator assembly which operates to project the contained discharge element of the toy for generating a foam string discharge. A toy character or accessory body includes a reservoir, which may be in an appendage to the toy character body in some embodiments. An inlet port on a first outer portion of the housing member is provided for receiving a supply of pressurized or aerosol foam for being maintained in the reservoir. A one-way valve is provided at the inlet port, and an outlet port on a second outer portion of the housing member with an outlet valve at the outlet port may be employed for generating the foam string discharge from the second outer portion of the housing member. An actuator may be provided for engagement with the outlet valve for projecting discharge of the pressurized or aerosol foam contained in the reservoir in generating the foam string discharge. Additionally, related inventions address integrated inlet channel, reservoir, and valve use and clean-out of handheld toy products of generated foam or string discharge of a foamable resinous composition launched foam discharge and addressing drying of the product with open access or tools for cleaning of the reservoir cavities to ensure the life of toy structures.

### BRIEF DESCRIPTION OF THE DRAWINGS

FIG. 1A is an illustration of a rechargeable shooting reservoir attached to a toy character in accordance with one embodiment of the invention;

FIG. 1B is an illustration of a rechargeable shooting reservoir removed from a toy character in accordance with one embodiment of the invention;

FIG. 1C is an illustration of a rechargeable shooting reservoir attached to a toy character in accordance with one embodiment of the invention illustrated in a different configuration;

FIG. 1D is an illustration of a rechargeable shooting reservoir embedded into an arm or appendage of a toy character in accordance with one embodiment of the invention;

FIG. 1E is an illustration of a rechargeable shooting reservoir embedded into an appendage of a toy character and showing the reservoir in a cross section view in accordance with one embodiment of the invention;

FIG. 2A is an illustration of a rechargeable shooting reservoir with a canister of pressurized foam used to charge the reservoir in accordance with one embodiment of the invention;

FIG. 2B is an illustration of a rechargeable shooting reservoir with a canister of pressurized foam connected thereto and used to charge the reservoir in accordance with one embodiment of the invention;

FIG. 2C is an illustration of a rechargeable shooting reservoir shooting pressurized foam in accordance with one embodiment of the invention;

FIG. 3A is an illustration of a rechargeable shooting reservoir in accordance with one embodiment of the invention;

FIG. 3B is an exploded view of a rechargeable shooting reservoir in accordance with one embodiment of the invention;

FIG. 3C is an exploded cross-sectional view of a rechargeable shooting reservoir in accordance with one embodiment of the invention;

FIG. 3D is a cross-sectional view of a rechargeable shooting reservoir in a closed configuration in accordance with one embodiment of the invention;

FIG. 3E is a cross-sectional view of a rechargeable shooting reservoir in an opened configuration in accordance with one embodiment of the invention;

FIG. 4A is a rechargeable shooting reservoir in accordance with one embodiment of the invention;

FIG. 4B is an exploded view of a rechargeable shooting reservoir in accordance with one embodiment of the invention;

FIG. 4C is a cross-sectional exploded view of a rechargeable shooting reservoir in a open configuration in accordance with one embodiment of the invention;

FIG. 4D is a cross-sectional view of a rechargeable shooting reservoir in a closed configuration in accordance with one embodiment of the invention;

FIG. 4E is a cross-sectional view of a rechargeable shooting reservoir in an opened configuration in accordance with one embodiment of the invention;

FIG. 5A is a rechargeable shooting reservoir in a closed configuration in accordance with one embodiment of the invention;

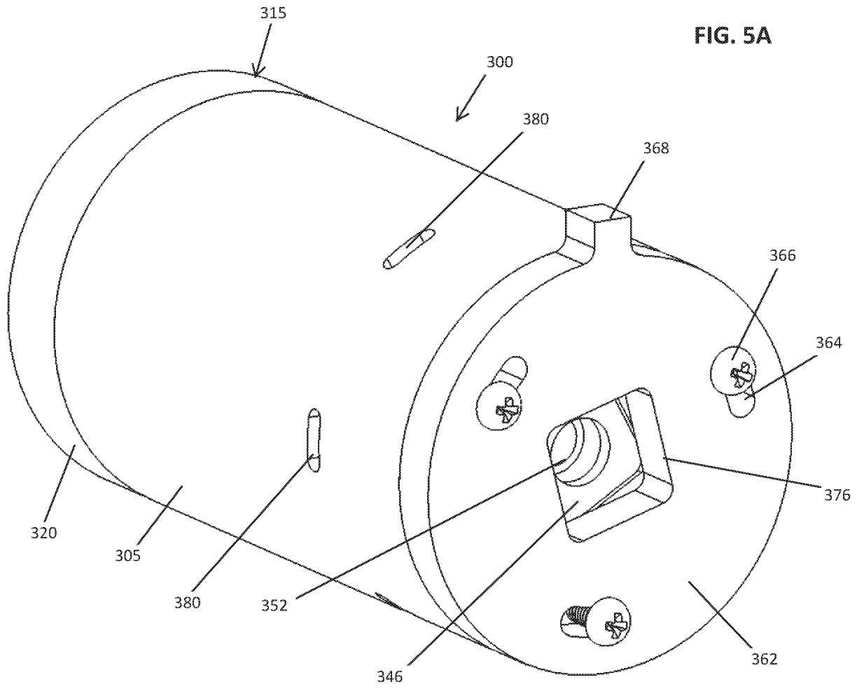

FIG. 5B is an exploded view of a rechargeable shooting reservoir in a closed configuration in accordance with one embodiment of the invention;

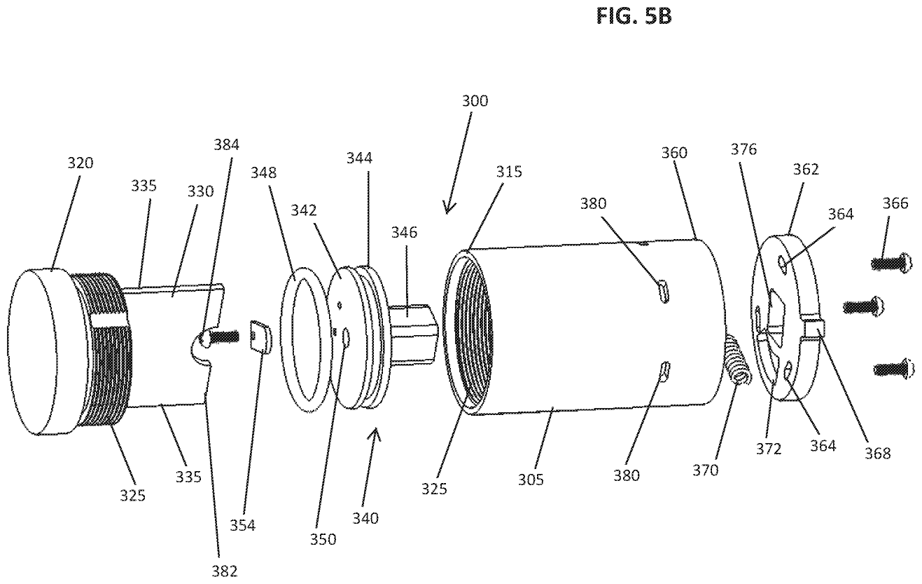

FIG. 5C is a cross-sectional exploded view of a rechargeable shooting reservoir in accordance with one embodiment of the invention;

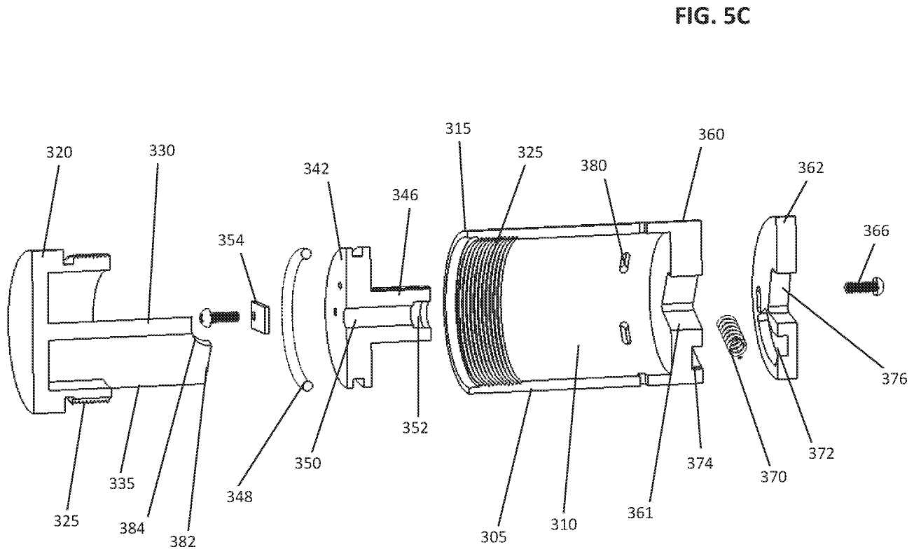

FIG. 5D is another cross-sectional view of a rechargeable shooting reservoir in a closed configuration in accordance with one embodiment of the invention;

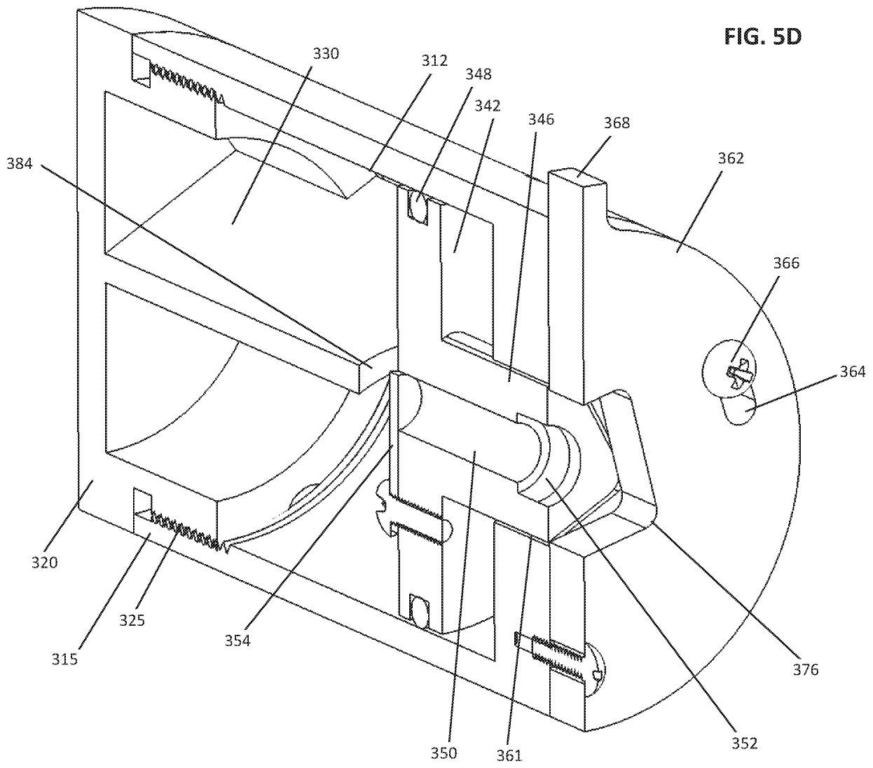

FIG. 5E is a cross-sectional view of a rechargeable shooting reservoir in a closed configuration in accordance with one embodiment of the invention;

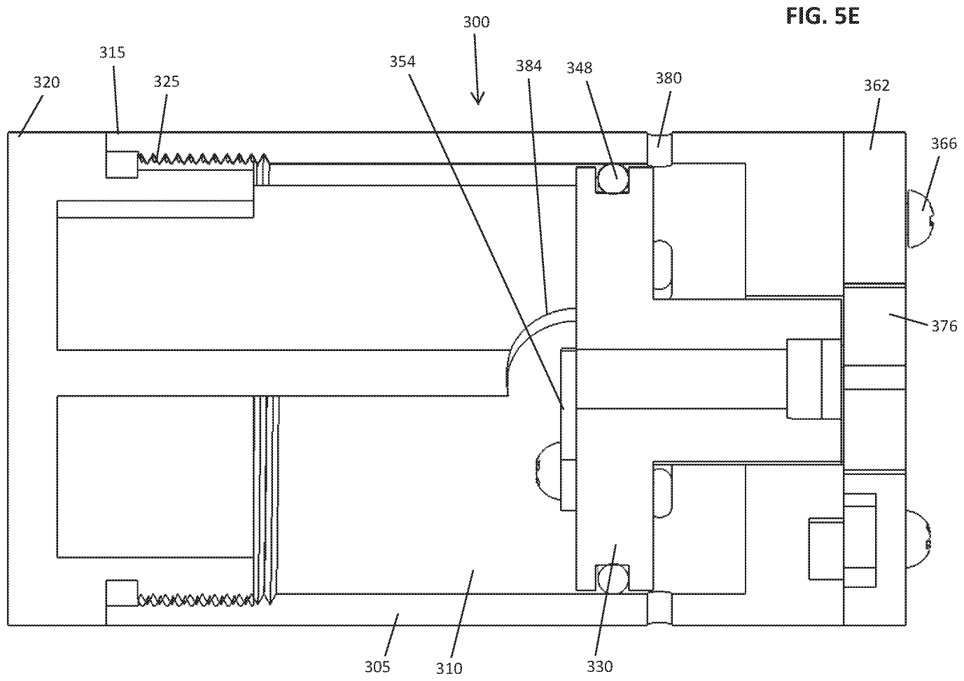

FIG. 5F is a cross-sectional exploded view of a rechargeable shooting reservoir in a opened configuration in accordance with one embodiment of the invention;

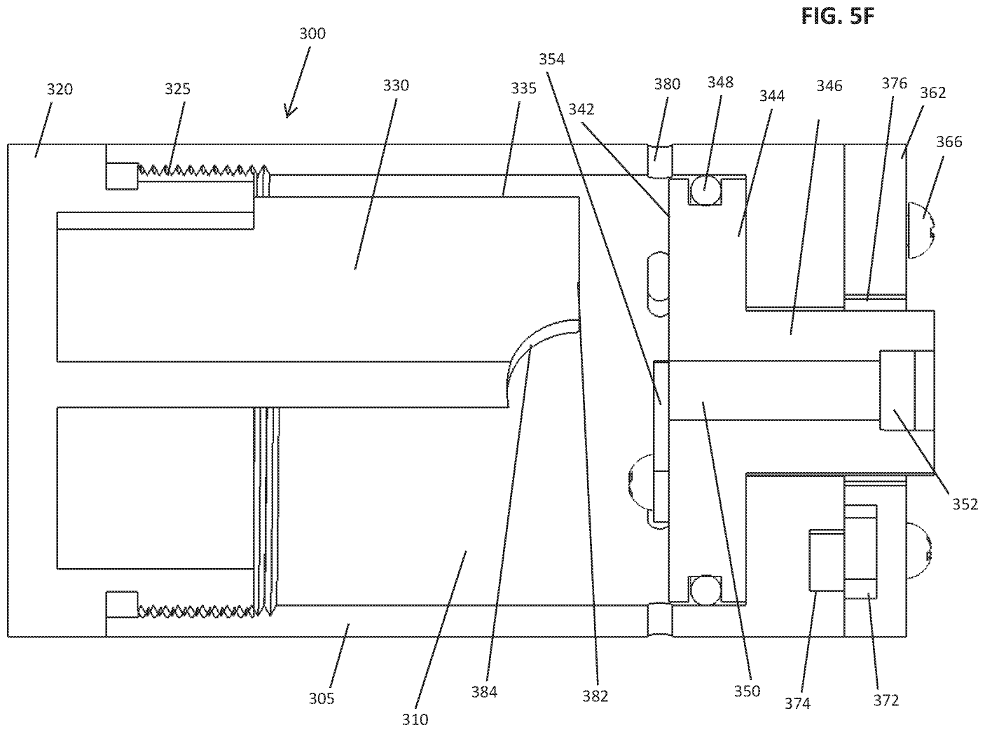

FIG. 6A is an illustration of various canister connectors used to attach a rechargeable shooting reservoir to a canister in accordance with various embodiments of the invention;

FIG. 6B is another view of various canister connectors used to attach a rechargeable shooting reservoir to a canister in accordance with various embodiments of the invention;

FIG. 6C is another view of various canister connectors used to attach a rechargeable shooting reservoir to a canister in accordance with various embodiments of the invention;

FIG. 6D is an illustration of various canister connectors used to attach a rechargeable shooting reservoir to a canister in accordance with various embodiments of the invention;

FIG. 7A is a partial exploded cross-sectional view of a canister connector used to attach a rechargeable shooting reservoir to a canister in accordance with an embodiment of the invention;

FIG. 7B is a partial cross-sectional view of a canister connector used to attach a rechargeable shooting reservoir to a canister in accordance with an embodiment of the invention;

FIG. 7C is a partial cross-sectional view of a canister connector used to attach a rechargeable shooting reservoir to a canister in accordance with an embodiment of the invention;

FIG. 8A is a partial exploded cross-sectional view of a canister connector used to attach a rechargeable shooting reservoir to a canister in accordance with an embodiment of the invention;

FIG. 8B is a partial cross-sectional view of a canister connector used to attach a rechargeable shooting reservoir to a canister in accordance with an embodiment of the invention;

FIG. 8C is a partial cross-sectional view of a canister connector used to attach a rechargeable shooting reservoir to a canister in accordance with an embodiment of the invention;

FIG. 9A is a partial exploded view of a canister connector used to attach a rechargeable shooting reservoir to a canister in accordance with an embodiment of the invention;

FIG. 9B is a view of a canister connector used to attach a rechargeable shooting reservoir to a canister in accordance with an embodiment of the invention;

FIG. 9C is a view of a canister connector used to attach a rechargeable shooting reservoir to a canister in accordance with an embodiment of the invention;

FIG. 10A is a rechargeable shooting reservoir in a closed configuration in accordance with one embodiment of the invention;

FIG. 10B is an exploded view of a rechargeable shooting reservoir in accordance with one embodiment of the invention;

FIG. 10C is a cross-sectional exploded view of a rechargeable shooting reservoir in accordance with one embodiment of the invention;

FIG. 10D is a cross-sectional view of a rechargeable shooting reservoir in a closed configuration in accordance with one embodiment of the invention;

FIG. 10E is a cross-sectional view of a rechargeable shooting reservoir in an opened configuration in accordance with one embodiment of the invention;

FIG. 11A is a rechargeable shooting reservoir positioned in a figurine in accordance with one embodiment of the invention;

FIG. 11B is a cross-sectional view of a rechargeable shooting reservoir in accordance with one embodiment of the invention;

FIG. 11C is a cross-sectional view of a rechargeable shooting reservoir shown expelling foam in accordance with one embodiment of the invention; and

FIG. 11D is a cross-sectional view of a rechargeable shooting reservoir in accordance with one embodiment of the invention.

### DETAILED DESCRIPTION OF THE PREFERRED EMBODIMENTS

The following description is provided to enable those skilled in the art to make and use the described embodiments set forth in the best mode contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that inventive subject matter includes individual or combinations the embodiments in whole or in part, understood as allowing for additional factors not necessarily expressly described depending in part on context. Accordingly, the invention is not to be restricted except in light of the attached claims and their equivalents.

Other apparatus, methods, features and advantages will be, or will become, apparent to one with skill in the art upon examination of the following figures and detailed description. It is intended that all such additional structures, methods, features and advantages are within the scope of the inventions. Nothing in this section should be taken as a limitation on the claims. Further aspects and advantages are discussed below.

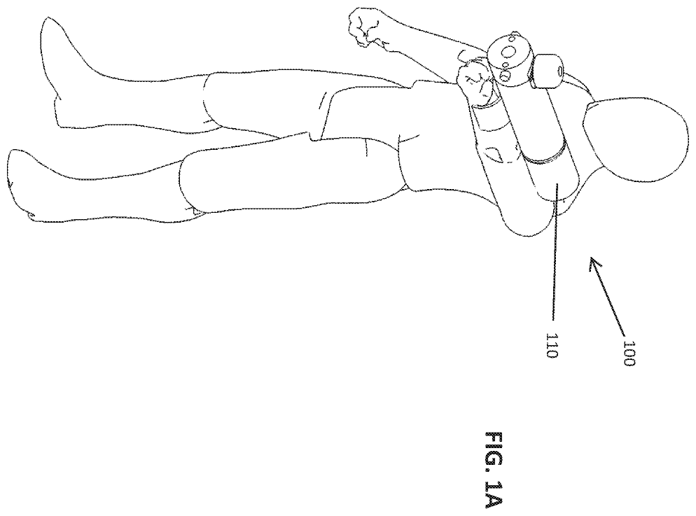

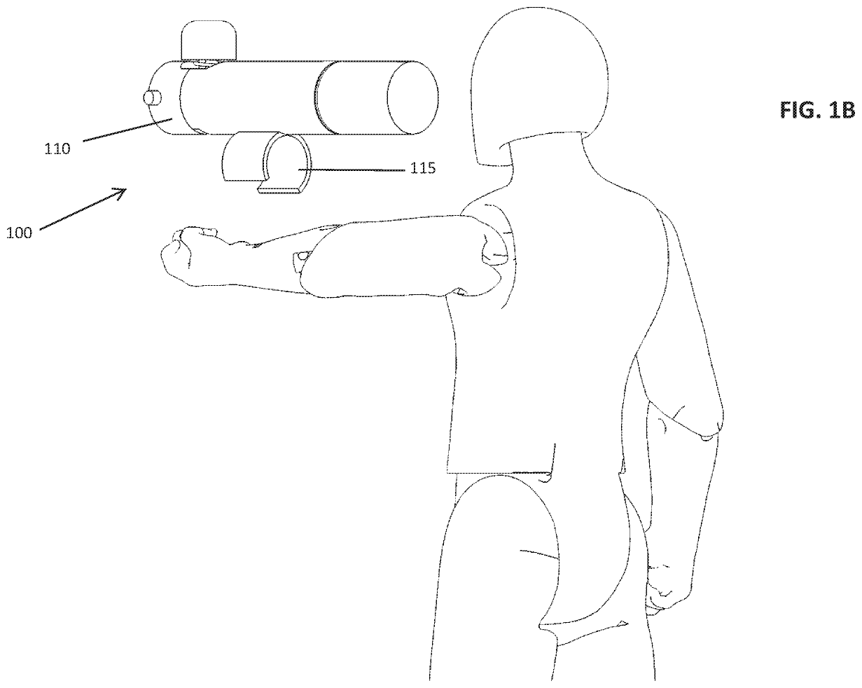

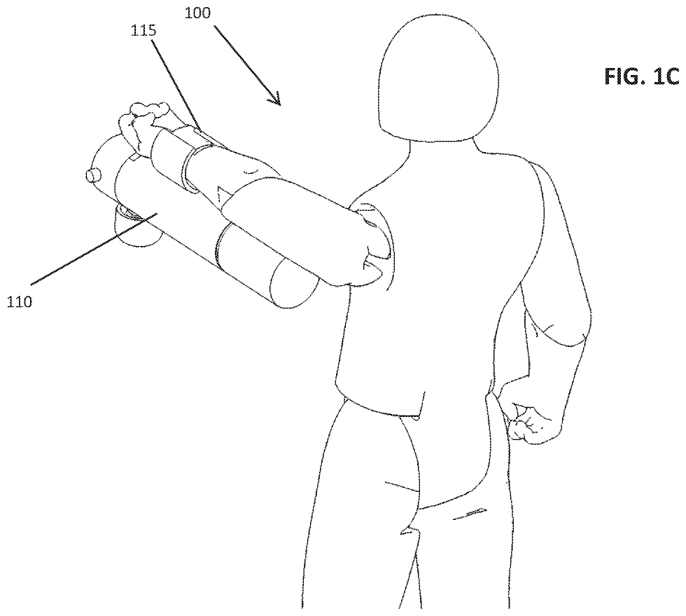

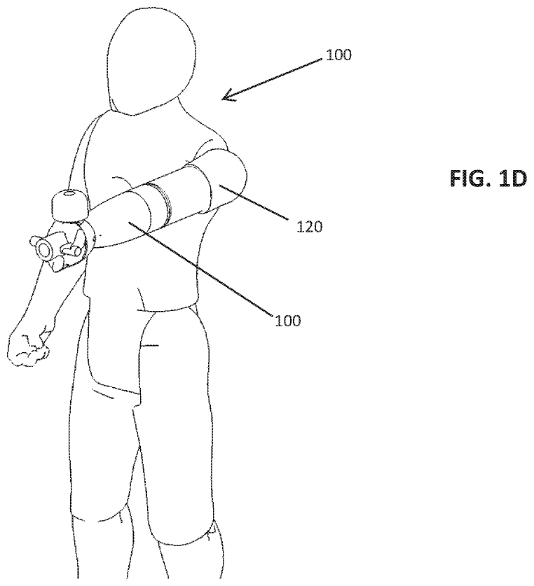

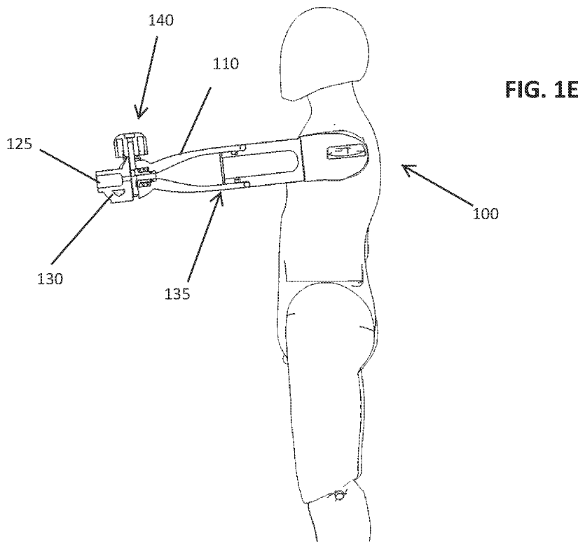

With reference to FIGS. 1A-1E, and for present discussion FIG. 1A illustrates a foam composition 55 string Shooting Figurine 100, which incorporates a rechargeable shooting reservoir 110 configured for charging and use with a separate toy product, figurine, or accessory used with or integrally mounted inside a toy. The reservoir 110 can be removably or permanently mounted to a toy (as illustrated with a mount 115 or integrated into a figurine's body appendage 120, with such appendage including a housing member for the reservoir).

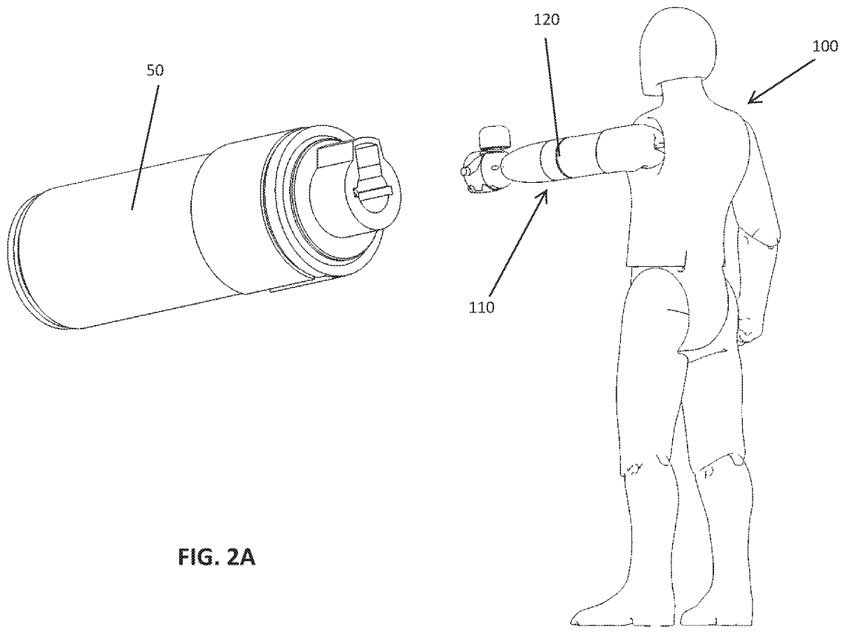

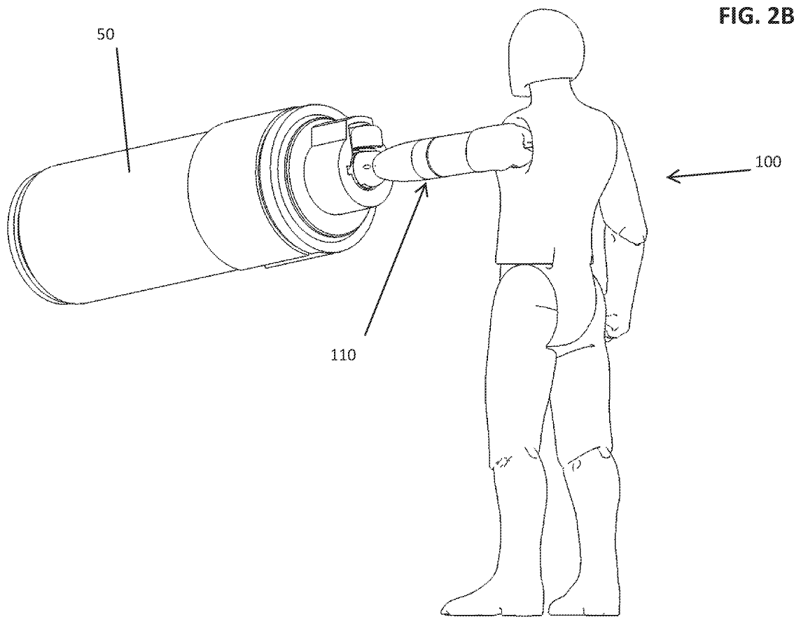

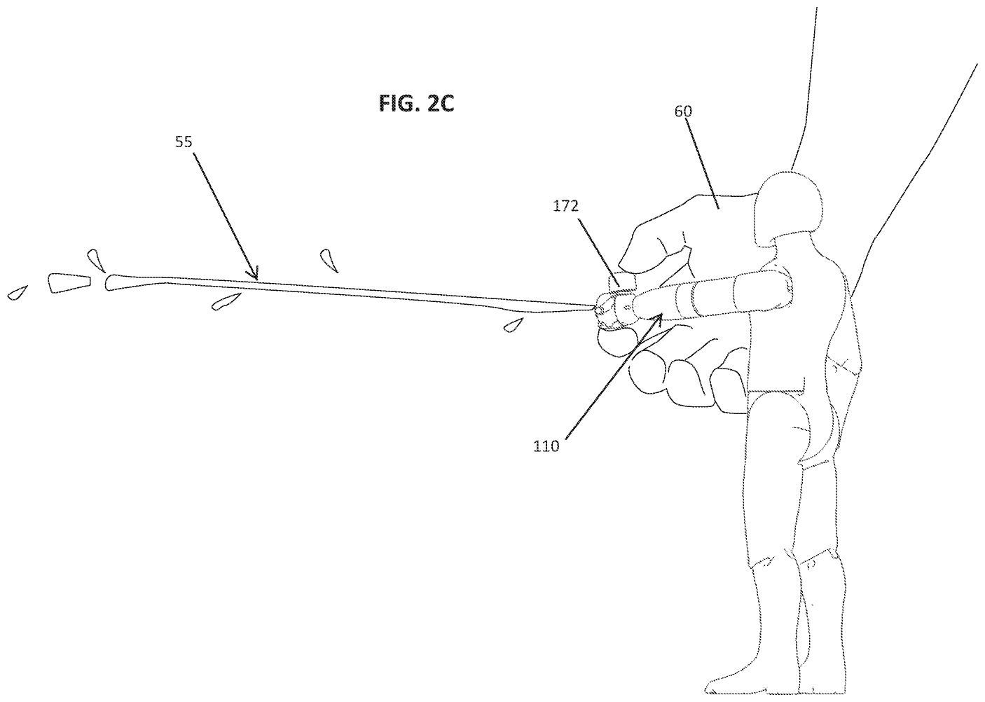

With reference to FIGS. 1E-2B, an inlet/outlet port 125 (referred generally herein as port 125) is shown on a first outer portion 130 of the housing member 135 of the shooting reservoir 110 configured to receive a supply of pressurized or aerosol foam held in a canister 50 for being maintained in the reservoir, via a one-way valve mechanism 140 at the port 125. To fill the shooting reservoir, the canister 50 is inserted onto the port 125 for a predetermined amount of time (discussed herein). Once filled, the canister 50 is removed, and a user 60 is able to press a button 172 to activate the release of the pressurized foam 55, wherein the foam 55 is shot out of the reservoir 110.

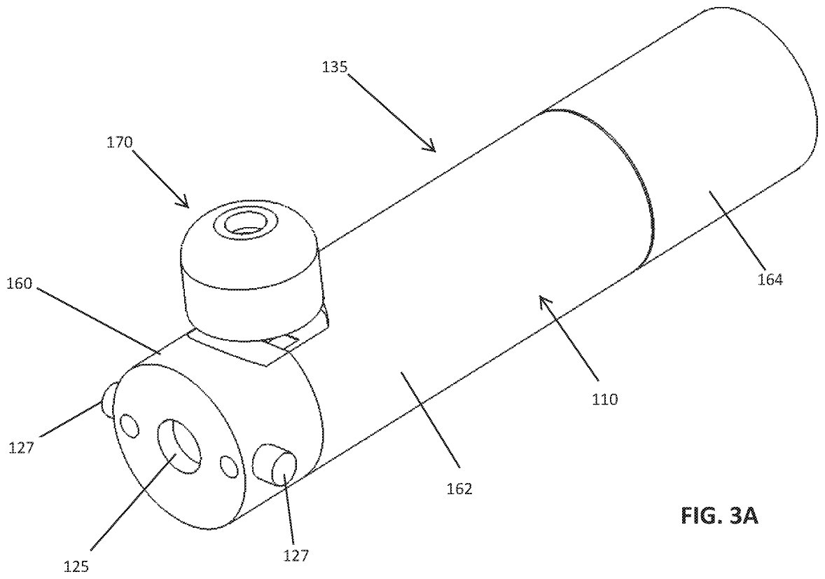

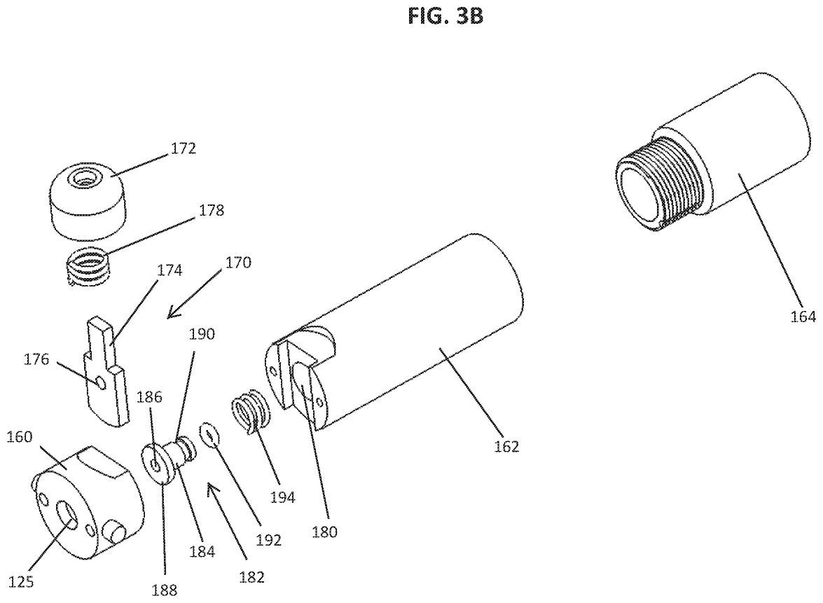

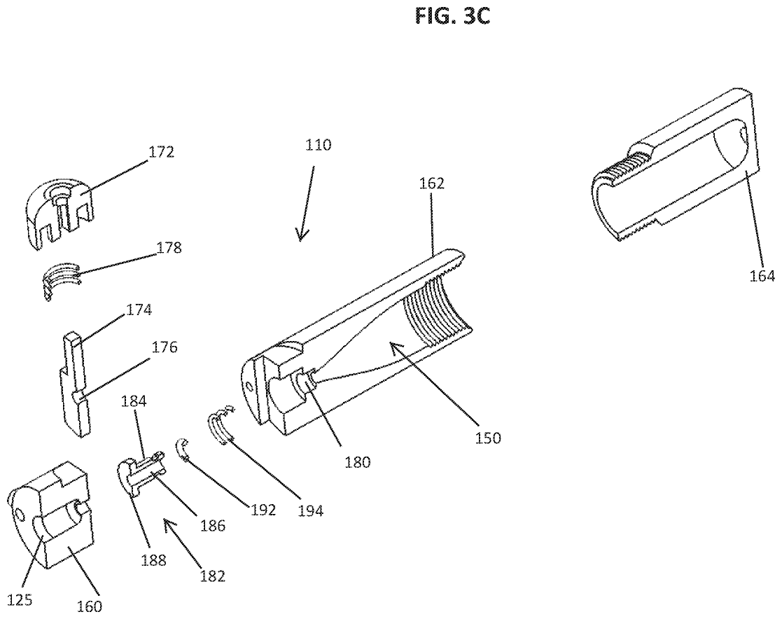

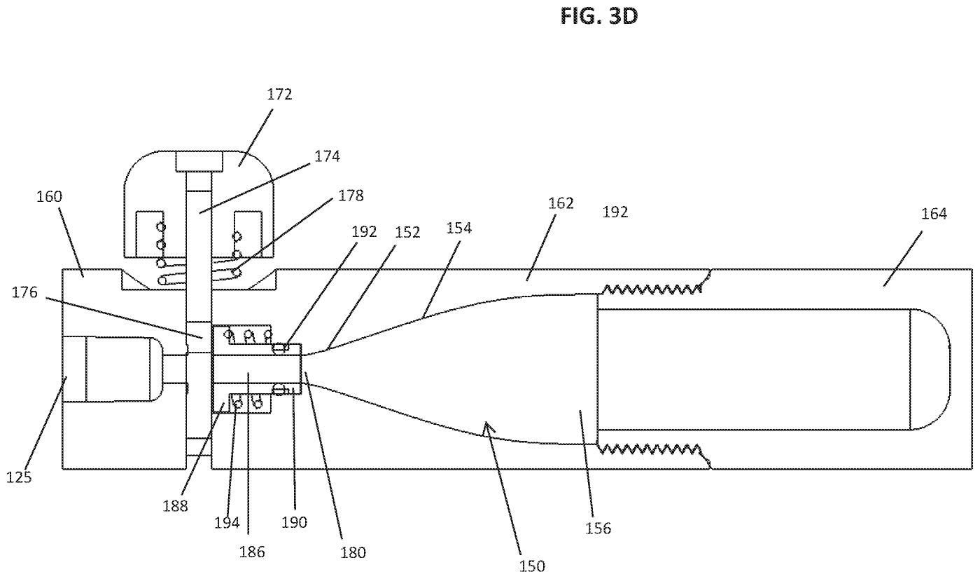

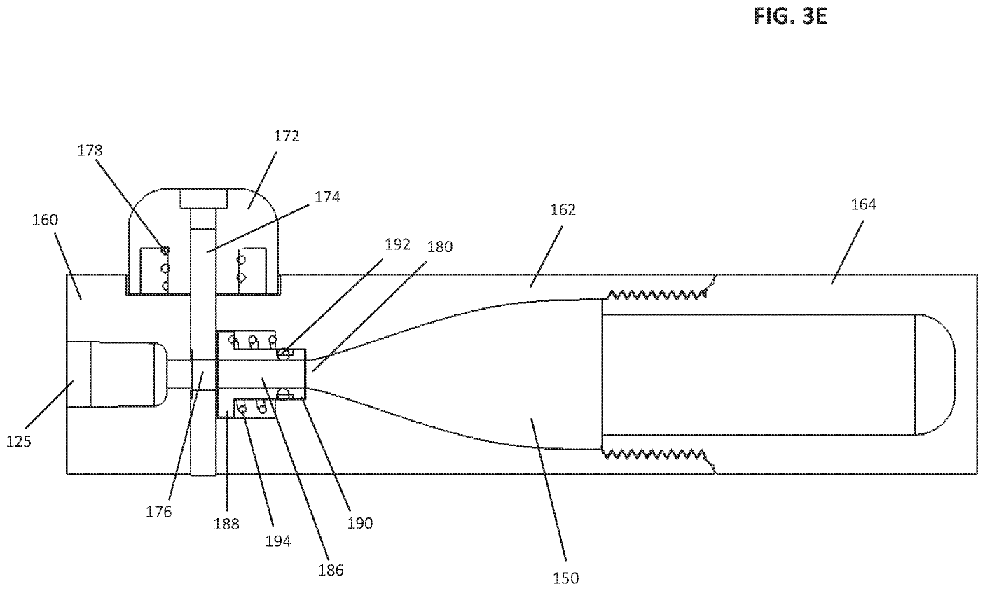

With further reference to FIGS. 3A-3E, there is shown in greater detail the reservoir 110 in accordance to one embodiment of the invention.

The reservoir 110 includes a housing member 135 with a container 150 internally defined by the housing member 135 to hold a supply of pressurized or aerosol foam. The foam is loaded and expelled through an inlet/outlet port 125 defined in a front portion 160 of the housing member 135. The housing member 135 as noted includes the front portion 160 but further includes a mid-section 162 and an end portion 164 or end cap. As illustrated, the end portion 164 may be removed from the mid-section 162 to help facilitate cleaning of the internal container 150.

To control the intake and release of the foam, the front portion 160 of the housing member 135 includes a valve mechanism 170 that is adjacent to or in communication with the inlet/outlet port 125. The valve mechanism 170 is defined to include a manual activated button 172 that when pressed opens the port 125 for the ejection or filling of the foam. The button 172 is attached to a gate member 174 that has an aperture 176. The button 172 when pressed moves the gate member 174 such that the aperture 176 aligns with both the port 125 and a channel 180 into the internal container 150 such that the alignment creates a single conduit for the foam to travel either inwardly and/or outwardly. The button 172 is biased upwardly by a gate spring 178 such that the gate member 174 is positioned in a normally closed position, i.e., the aperture 176 is not aligned with the port 125 and channel 180. In addition, to ensure foam does not leak when in the closed position, the valve mechanism 170 further includes a stem seal 182 inserted into the channel 180 of the of the mid-section 162 of the housing member 135. The stem seal 182 has a plug 184 bored through 186 to maintain the single conduit for the foam to travel. The plug 184 has a front face 188 and a stem 190. The stem 190 has an O-ring 192 a stem spring 194. The stem spring 194 biases the front face 188 against the gate member 174, such that pressurized foam cannot leak at the interface of the gate member 174. The O-ring 192 further prevents leakage around the stem plug 184 and allows it to move back and forth inside the channel 180 as needed to maintain the seal on the valve mechanism 170.

Another important aspect of an embodiment of the invention is the internal shape of the internal container 150. It has been found that an internal container 150 shaped to have a narrow neck 152 that expands or tapers outwardly 154 to a main tank 156, which extends through the end portion 164 works best with the pressurized foam. Since the foam may harden along with edges or near the port adjacent the neck over time, have a single inlet/outlet port to fill assists in maintaining a clear port. As the user fills the reservoir 110, high pressurized foam enters the neck and will dislodge and push hardened foam towards the end portion and out of the way of the incoming foam. As such, the next time the user expels the foam, any hardened particles are pressed towards the end portion out of the way of the incoming pressurized foam thus preventing a clog or malfunction. The user can thus play with the toy multiple times before the end portion would have to be removed for cleaning.

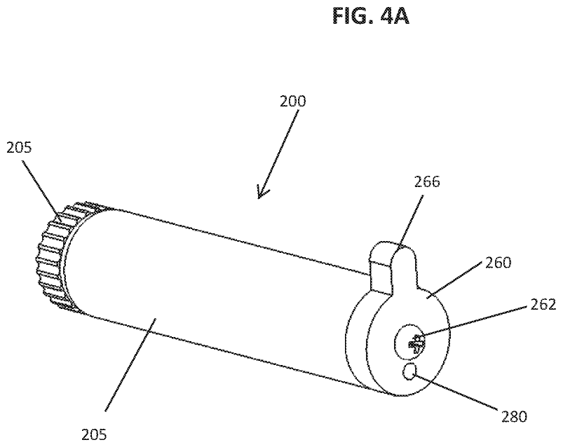

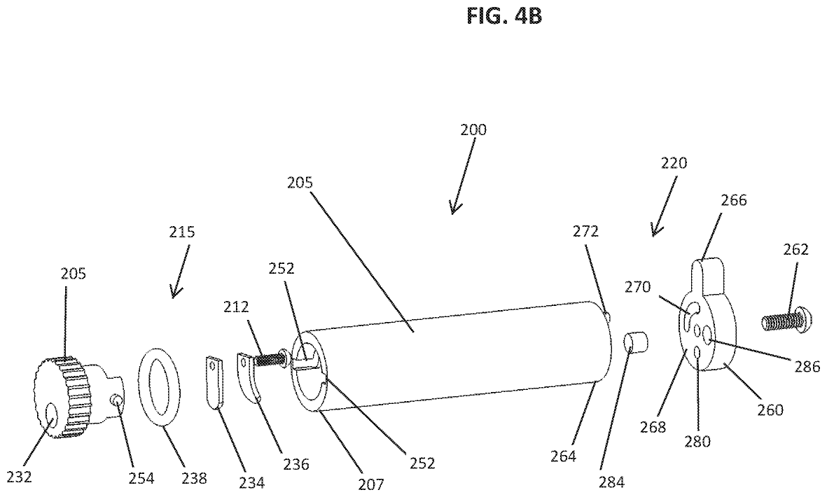

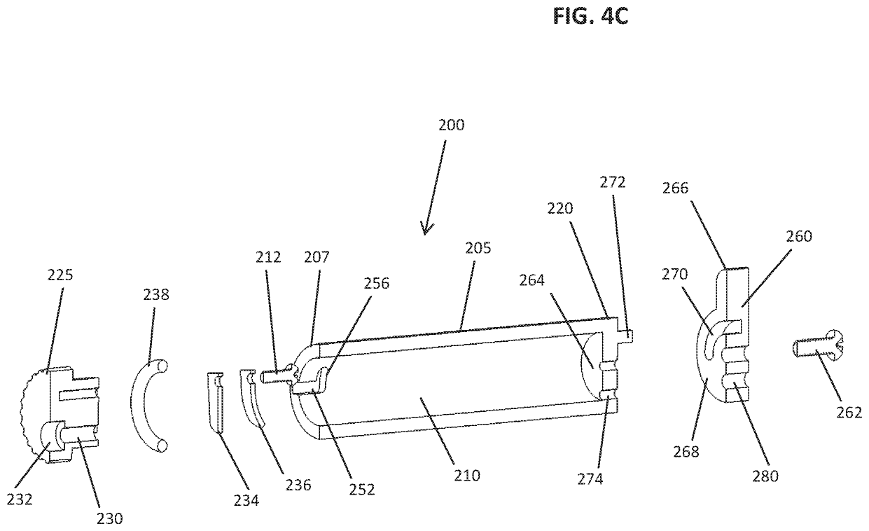

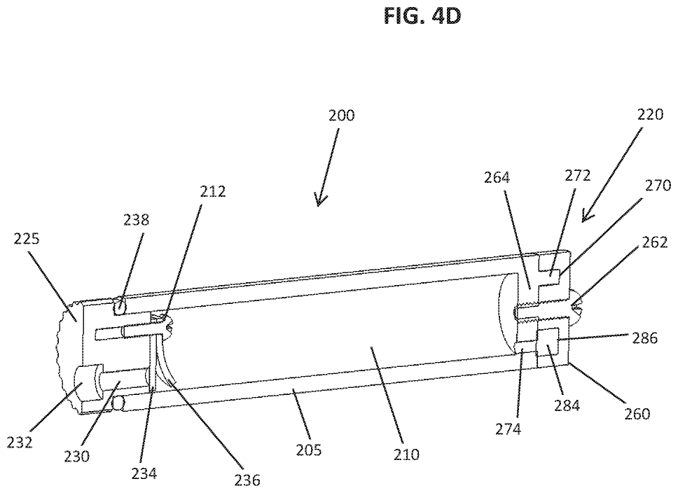

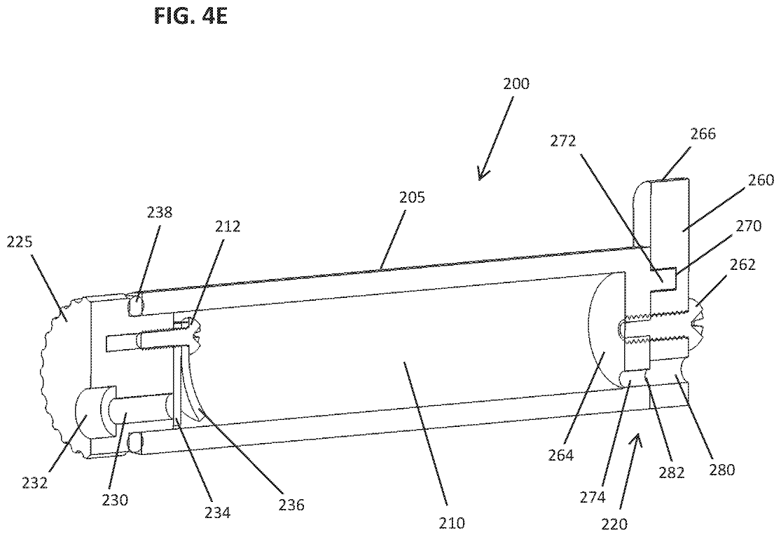

Referring now to FIGS. 4A through 4F there is illustrated in another embodiment a rechargeable shooting reservoir 200. The reservoir 200 includes a cylinder 205 with an internal container 210 for holding the pressurized foam. The reservoir 200 has an inlet end 215 for receiving the pressurized foam and an exit end 220 to expel the pressurized foam. The inlet end 215 includes a inlet cap 225 that is removably secured to the inlet end 207 on the cylinder 205. The inlet cap 225 has an inlet channel 230 with a receptor opening 232 sized to receive a tip of the canister (with the pressurized foam). The receptor opening 232 leads through the inlet channel 230 into the internal container 210. A pair of flange members 234 and 236 are positioned in the internal container 210 and secured (by a fastener 212) to the inlet cap 225 covering the inlet channel 230 from the internal container 210. When the tip of the canister is inserted into the receptor opening 232 and pressurized foam is injected into channel 230, pressure will push open flexible flange 234 allowing chamber 210 to fill while rigid flange 236 prevents over extension of flexible flange member 234. When the internal container is filled, and the canister is removed, the pressurized foam will expand and press against the first flexible flange member 234 to seal the inlet channel and prevent foam from escaping the inlet channel 230. To further help seal the inlet cap 225 to the cylinder 205 an O-ring 238 may be used around an end of the inlet cap 225. To removably secure the inlet cap 225 to the cylinder 205, the inlet end 207 of the cylinder 205 includes a pair of diametrically opposed groove locks 252, and the inlet cap 225 includes a pair of corresponding pins 254 extending outwardly from the inlet cap. The pins 254 sit/ride in the groove locks 252, when the inlet cap 225 is properly inserted into the cylinder end 250, the inlet cap 225 can be rotated slightly such that the pins 254 rest in ends 256 of the groove locks 252, which prevents the inlet cap 225 from being pulled away from the cylinder end 250 without rotation.

The exit end 220 of the reservoir 200 is used to expel the pressurized foam contained within the internal container 210. This is accomplished with a rotatable exit cap 260. The rotatable exit cap is rotatably secured with a fastener 262 to a base end 264 of the cylinder 205. The exit cap 260 includes a handle or knob 266 which extends for a manual manipulation by a user. The exit cap 260 includes an inside face 268 with an arcuate recess 270 sized to receive a projection pin 272 extending from the base end 264 of the cylinder 205. Both the base end 264 and the exit cap 260 have apertures 274 and 280, respectively that when aligned create a channel 282 to expel the pressurized foam. The alignment occurs when the exit cap 260 is rotated to an opened position. The opened positioned or the alignment of the apertures occurs when the projection pin 272 is rotated the one end of the arcuate recess 270. To further help seal the aperture 274 in the base end 264 when in the closed position, a seal member 284 can be positioned within a closed aperture 286 on the inside face 268 that aligned over the aperture 274 in the base end 264 when the exit cap 260 is moved to the closed position.

Referring now to FIGS. SA through 5F, there is illustrated in another embodiment a rechargeable shooting reservoir 300. The reservoir 300 includes a cylinder 305 with an internal container 310 for holding the pressurized foam. The cylinder 305 has a bottom end 315 with a removable end cap 320. Cooperative threads 325 are used to secure the end cap 320 to the bottom end 315. This allows the end cap 320 to be removed for cleaning out the internal container 310. In addition, the end cap 320 may further include a wiper 330 with wiper edges 335 that extending along a portion of the surface wall 312 of the internal container 310. As such, when the end cap 320 is removed, the wiper edges 335 act to scrap or remove hardened foam stuck to the surface wall 312 of the internal container 310.

The reservoir 300 further includes a free-floating piston 340 positioned within the internal container 310. The piston 340 includes a piston base 342 that has an outer perimeter 344 matching in size and shape of the interior surface wall 312 of the internal container 310. The piston 340 further includes a piston rod 346 extending from the piston base 342. An O-ring 348 may also be positioned around the piston base 342 to assist in sealing the piston base against the interior surface wall to prevent the pressurized foam from leaking around the piston base. The piston rod 346 has a channel 350 and an inlet 352 to receive the pressurized foam from a canister. The tip of the canister would insert through the channel 350 and would press open a flexible flap 354 covering the channel 350 from inside the internal container 310. Once filled, the pressurized foam would press the flexible flap 354 closed. In addition, the pressurized foam would press against the piston base 342 trying to move the piston base 342 into an open configuration to expel the pressurized foam (explained below).

The cylinder 305 of the rechargeable shooting reservoir 300 further has a front end 360 that is attached to a rotatable top 362. The front end 360 includes a front-end aperture 361 sized and shaped to receive the piston rod 346. The top 362 includes one or more slots 364 sized to receive a fastener 366 to attach the top 362 to the front end 360. The slots 364 permit the top 362 to be rotated with respect to the front end 360. The top 362 further includes a boss 368 that a user can grasp to facilitate the manual rotation of the top 362 from a biased closed configuration to an open configuration. The top 362 is biased to the closed configuration by a spring 370 fitted into corresponding recesses 372 and 374 on opposing surfaces of the top 362 and the front end 360 respectively. The top 362 further includes an aperture 376, which when the top 362 is rotated to the open configuration (and against or compressing the spring 370), the aperture 376 aligns with a shape or profile of the piston rod 346 such that the pressurized foam pushing against the piston base 342 pushes the piston 340 to a forward position, where the piston rod extends into the aperture.

It being noted that in a closed configuration, holes 380 in the cylinder 305 are covered or separated by the piston base 342 from the internal container 310 holding the pressurized foam. However, in the opened configuration, the piston base 342, which is in the forward position, allows the holes 380 to be exposed to the pressurized foam causing the foam to exit out the holes at a high pressure emptying the internal container 310. The top 362 will return to the closed configuration when the cylinder is filled with the pressurized foam. The canister is pressed into the piston rod pushing the piston from the forward position such that the piston rod is no longer inserted into the aperture 376, which immediately releases the compressed spring 370 to return the top 362 to the closed configuration, which also seals the holes off from the pressurized foam.

Lastly, the wiper 330 may also include a front end 382 facing the piston 340 that includes a curved segment 384 to accommodate the flexible flap 354. The curved segment 384 may be further sized to limit the movement of the flexible flap 354. Additionally, the length of the wiper 330 can also limit how far the piston can travel into the internal container 310 and the piston base 342 would come into contact with the front end 382 of the wiper when being filled.

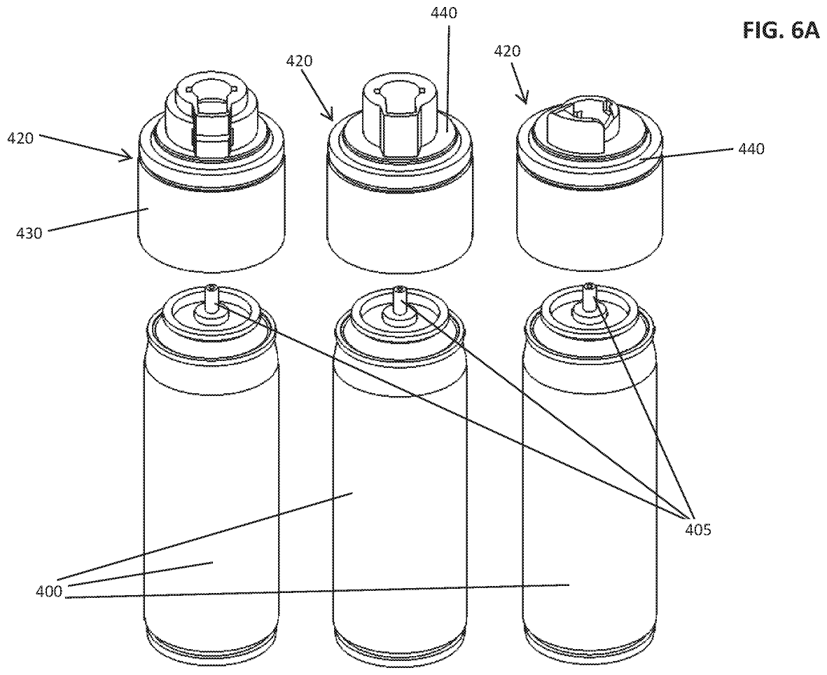

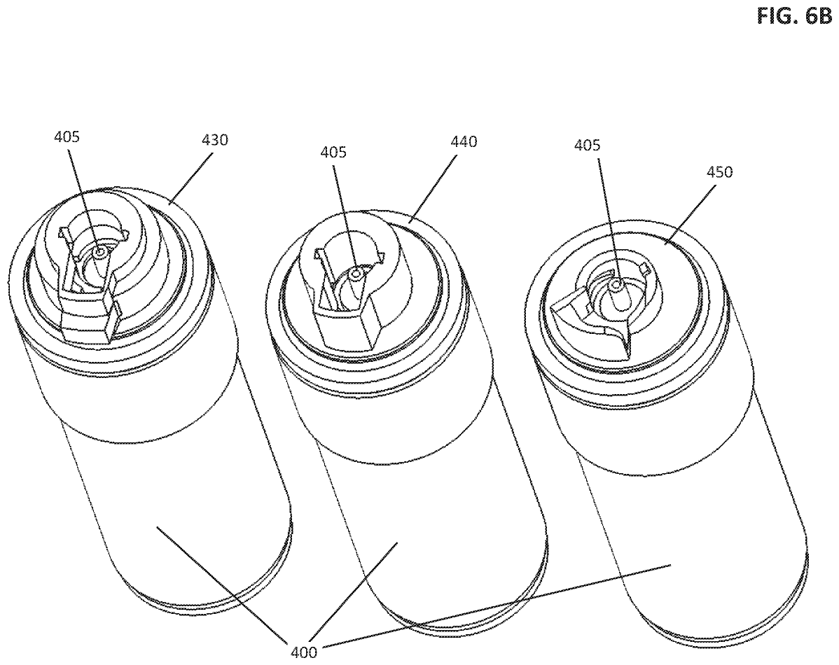

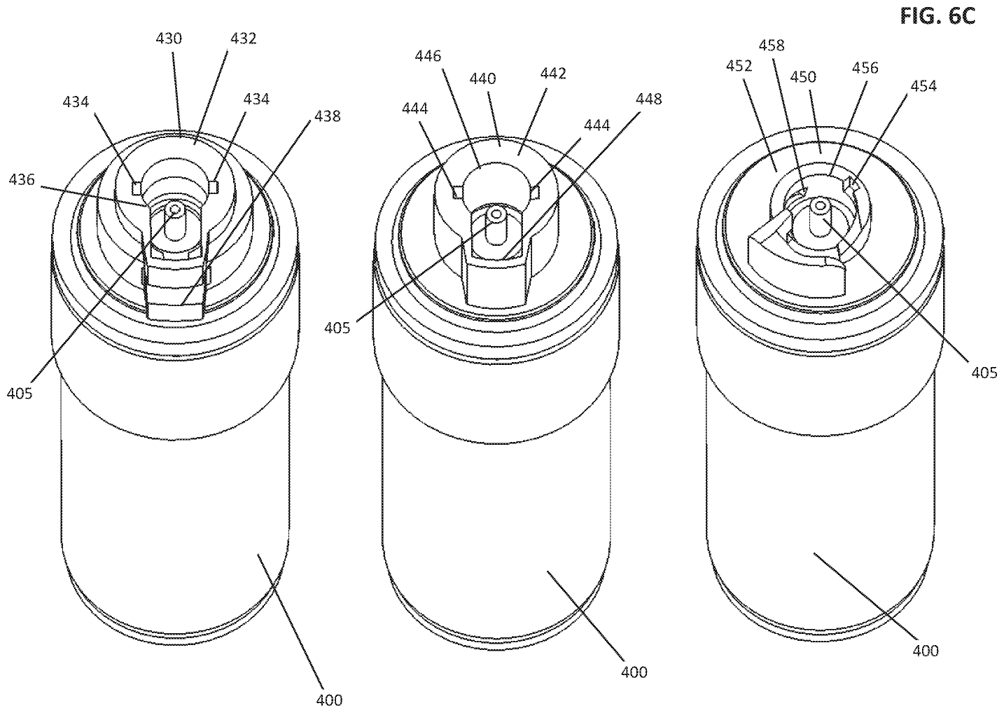

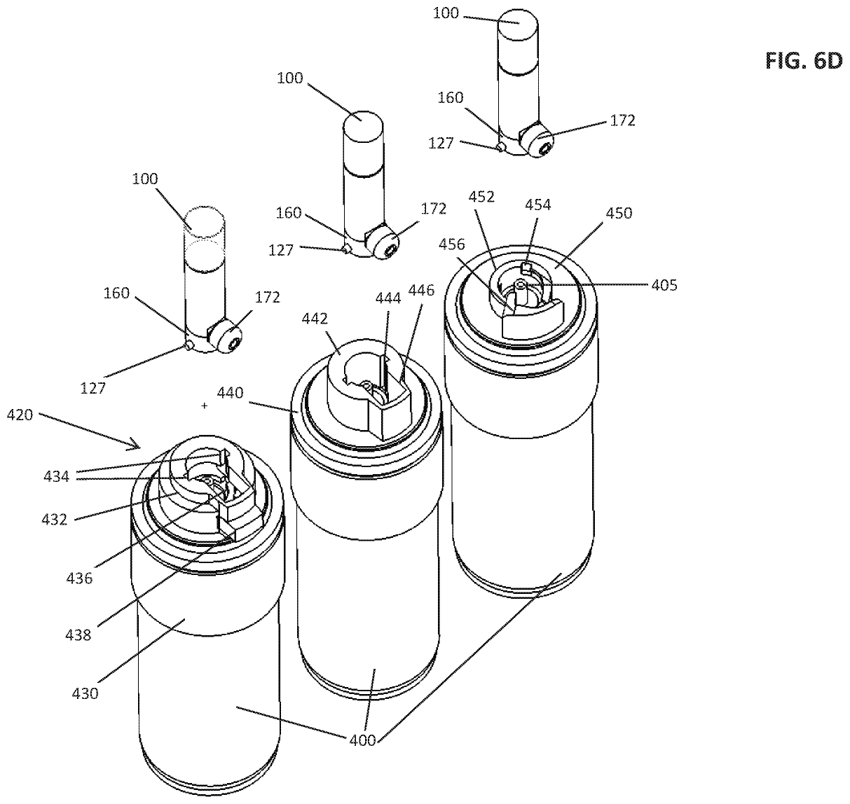

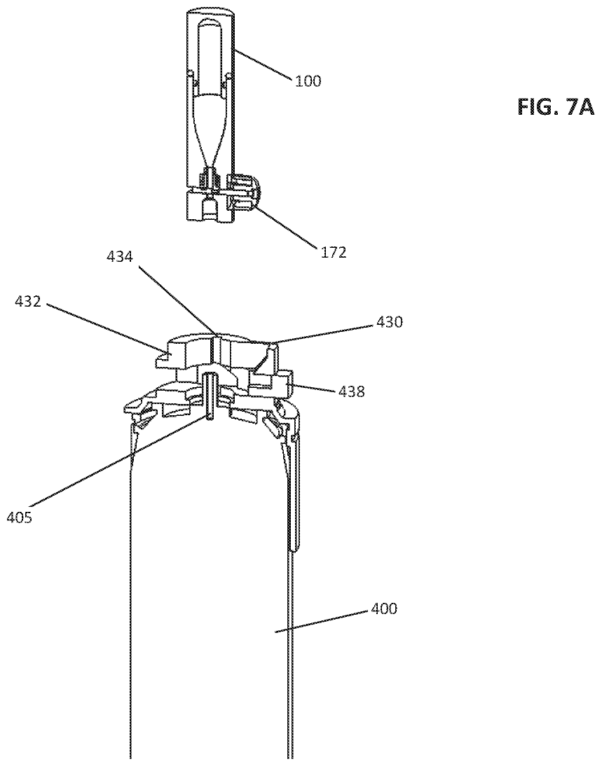

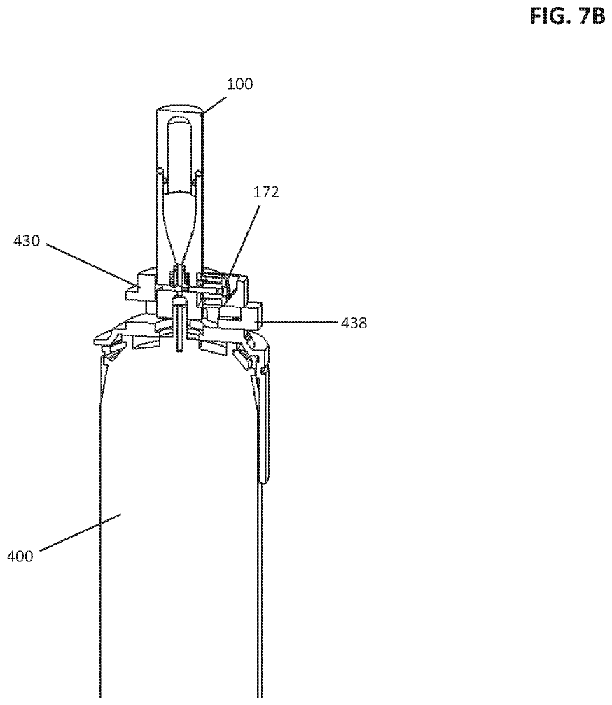

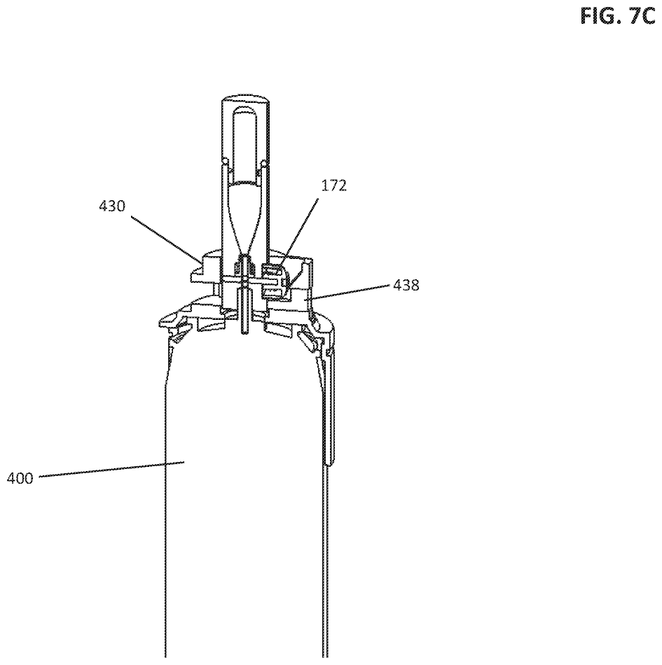

Referring now to FIGS. 6A through 6D there is illustrates a canister 400 containing a pressurized foam which can be used to fill one or more of the embodiments of the rechargeable shooting reservoirs disclosed herein. Each canister 400 has a tip 405 which when depressed or bent releases the pressurized foam. To facilitate an easier connection between the canister and the reservoirs, various can attachments 420 can be developed and which fit over the top of the canister and allow a user to connect the canister with the reservoir. In a first embodiment (FIGS. 7A-7C), a first can attachment 430 includes a head portion 432 with channels 434 to receive extension posts 127 extending from the front portion 160 of the housing member 135 of a reservoir 100. The user inserts the reservoir 100 such that the button 172 slides into an opening 436 in the head portion 432 and the tip 405 is inserted into the inlet/outlet port 125. The user then presses a tab 438 on the head portion 434 which presses the button 172 allowing the pressurized foam from inside the canister to enter the reservoir 100.

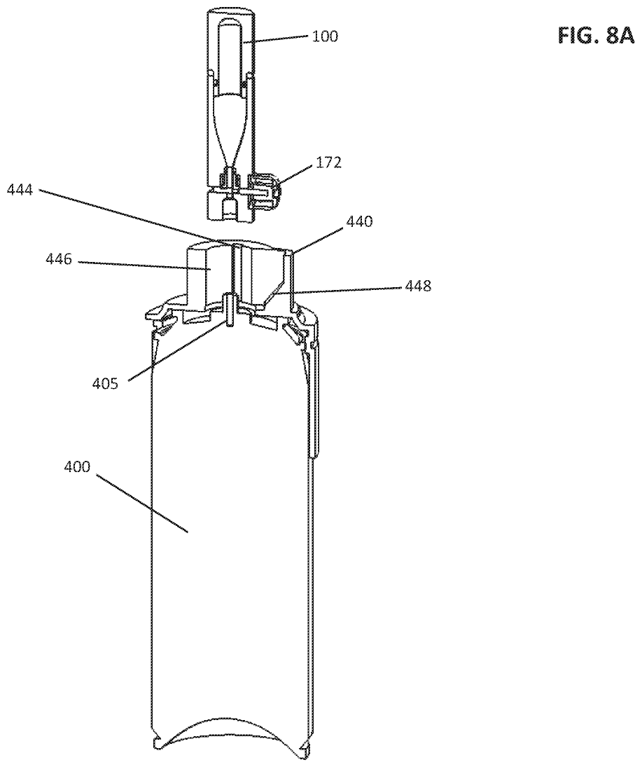

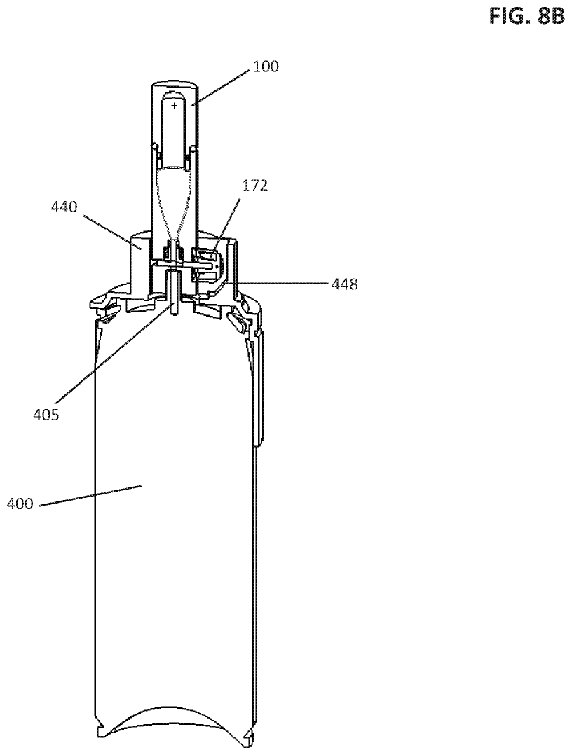

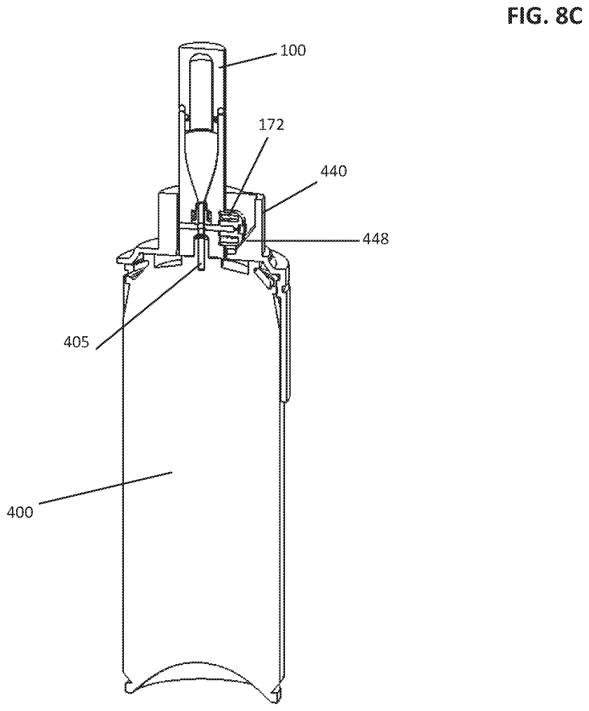

In a second embodiment (FIGS. 8A-8C), a second can attachment 440 includes a head portion 442 with channels 444 to receive extension posts 127. The user inserts the reservoir 100 such that the button 172 slides into an opening 446 in the head portion 442 and the tip 405 is inserted into the inlet/outlet port 125. In this embodiment the opening 446 further includes an inwardly tapered edge 448, such that as the user inserts the reservoir 100 the tapered edge 448 engages and presses the button 172 allowing the pressurized foam to enter the reservoir 100.

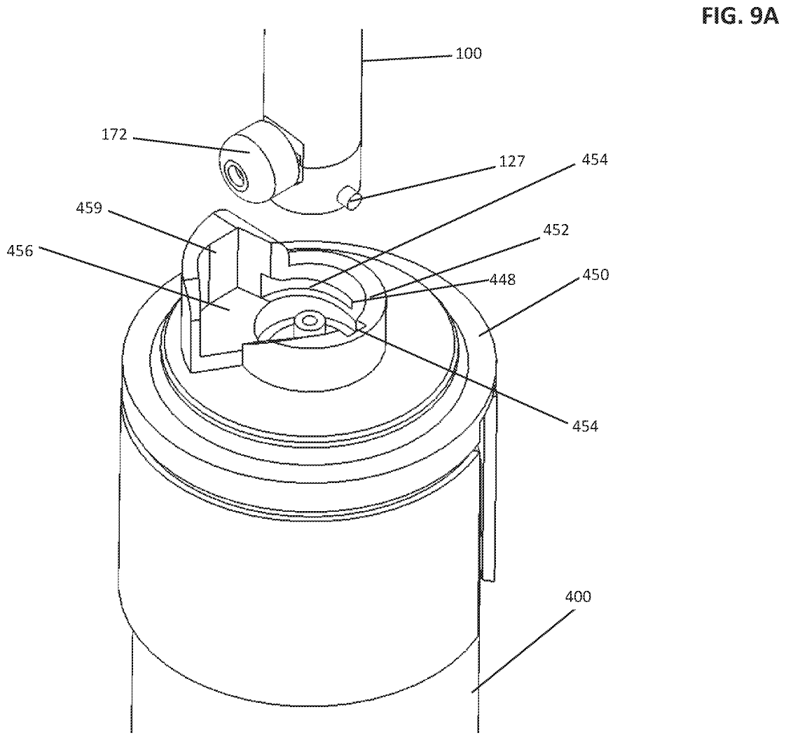

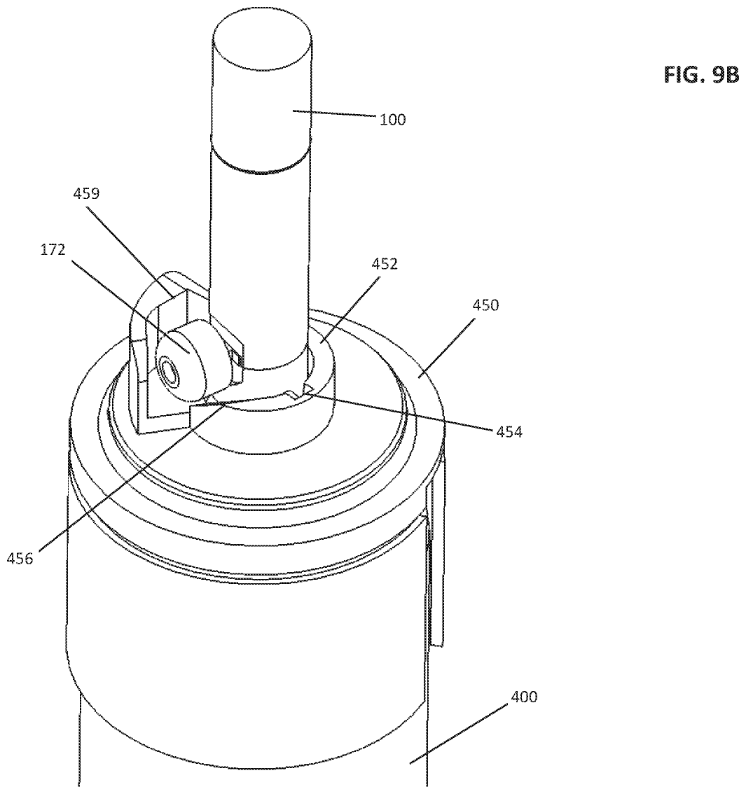

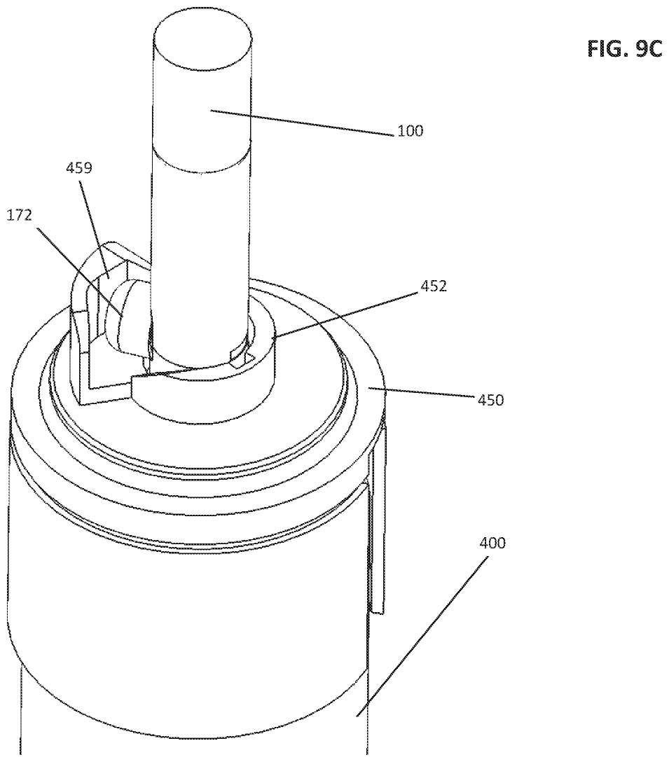

In a third embodiment (FIGS. 9A-9C), a third can attachment 450 includes a head portion 452 with channels 454 to receive extension posts 127. The user inserts the reservoir 100 into the opening 456 in the head portion 452 such that the extension posts 127 slide into the channels 454, which are angled downwardly towards the canister. The user then rotates the reservoir 100 until the posts 127 contact the ends 456 of the channels, at which time the reservoir 100 is filled with the pressurized foam and the user may remove the reservoir from the can attachment 450. As it rotates downwardly, the button 127 is pressed inwardly by the surface wall 459 of the opening.

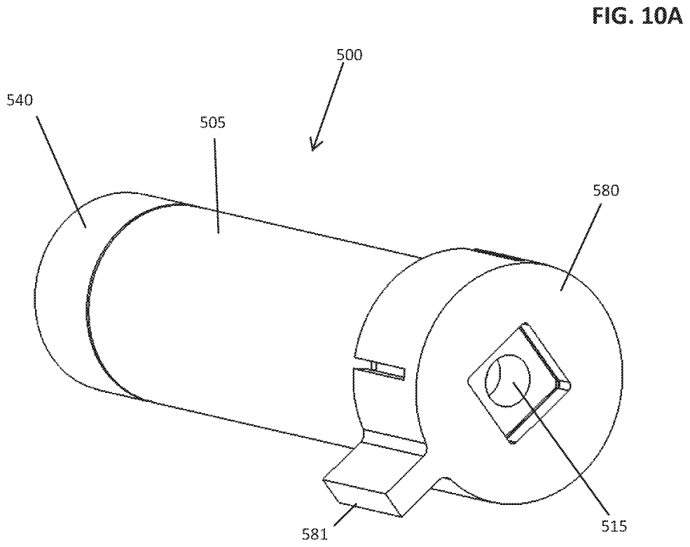

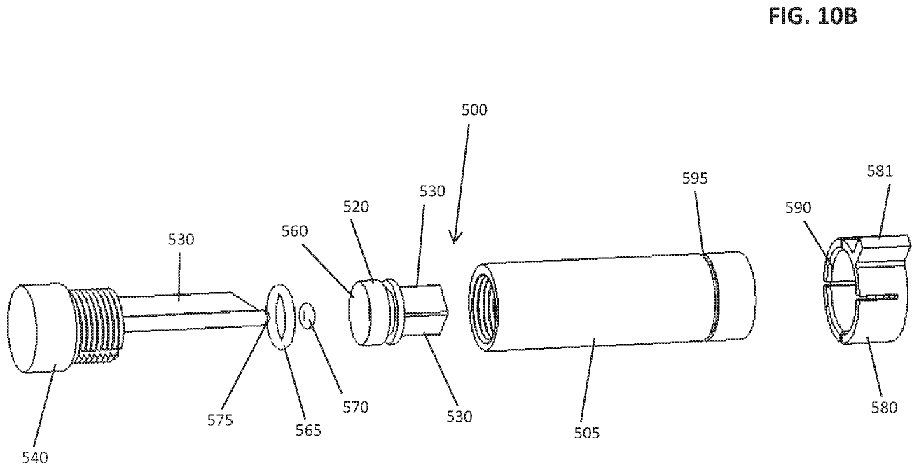

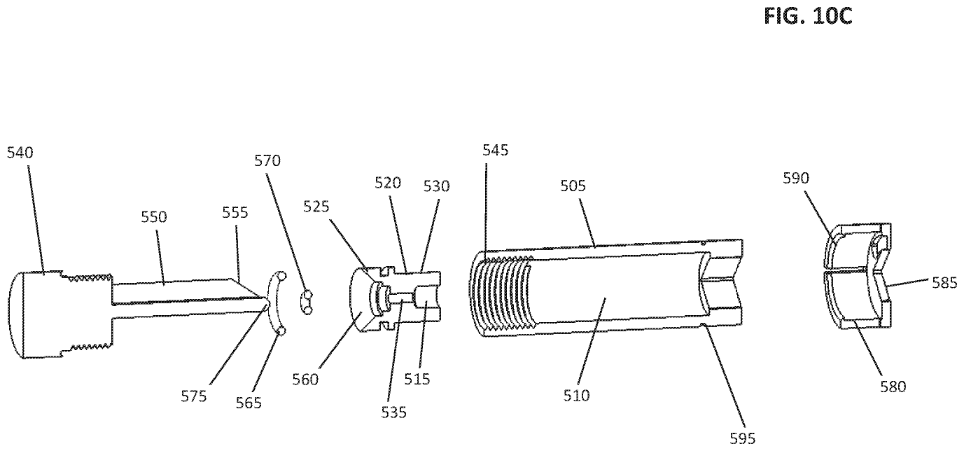

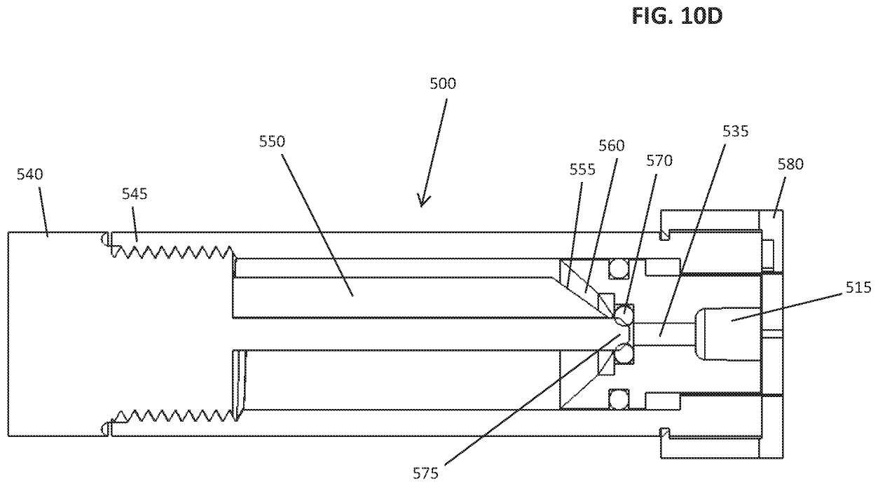

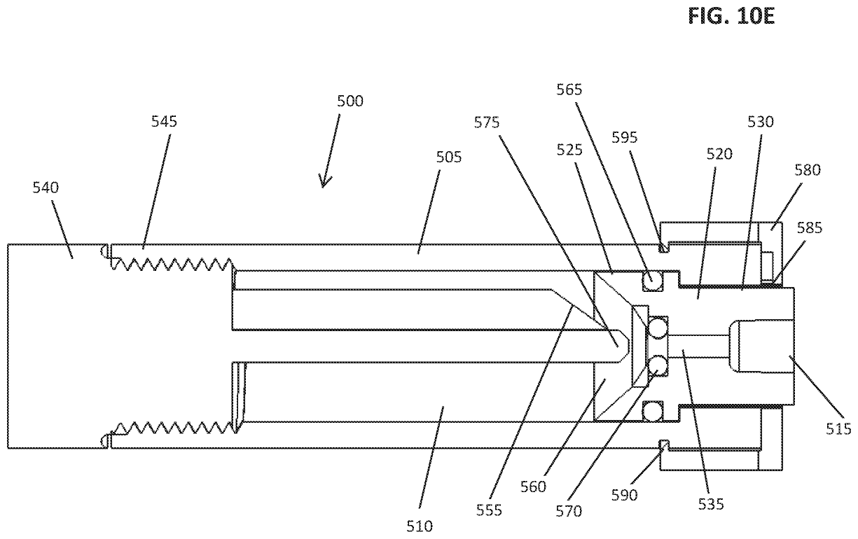

Referring now to FIGS. 10A through 10E, there is illustrated in another embodiment a rechargeable shooting reservoir 500. The reservoir 500 includes a cylinder 505 with an internal container 510 for holding the pressurized foam. The reservoir 500 using a single inlet/outlet 515 to receive and expel the foam. The inlet/outlet 515 is incorporated into a piston 520 fitted within the cylinder 505. The piston 520 has a piston head 525 and a piston rod 530. The piston rod 530 includes a piston channel 535 allowing fluid communication with between the internal container 510 and the inlet/outlet 515.

An end cap 540 threads into a cylinder end 545 which allows the end cap to be removed for cleaning. The end cap 540 further includes a wiper blade 550 extending through the cylinder 505 and has an angled front edge 555 that is profiled to sit in an angled face 560 on the piston head 525. A first O-ring 565 may be placed around the piston head to seal the piston against the internal container 510, while a second O-ring 570 may be placed in the piston head 525 to seal against a tip 575 extending from the wiper blade 550. As mentioned herein, the wiper blade 550 will scrap the surface on the internal container 510 when the end cap 540 is unscrewed, helping to clean the cylinder when the end cap is removed for cleaning purposes.

As noted above, the piston rod 530 is pressed inwardly such that the tip 575 seals against the piston end, closing the piston channel 535, when in the closed configuration. When filled, the pressurized foam biases the piston forward. However, the reservoir 500 will stay in the closed configuration until the user rotates the front cap 580 to an open configuration aligning an aperture 585 in the front cap 580 to the correct configuration that matches the piston rod 530. As soon as it aligns, the pressure pushes the piston forward such that the tip 575 no longer seals the piston channel, allowing the pressurized foam to escape. The front cap 580 may be maintained on the cylinder by including a flange 590 on the front cap that is indented inwardly to sit within a groove 595 around the cylinder. The user is further able to rotate the front cap 580 by grasping a protruding handle or boss 581.

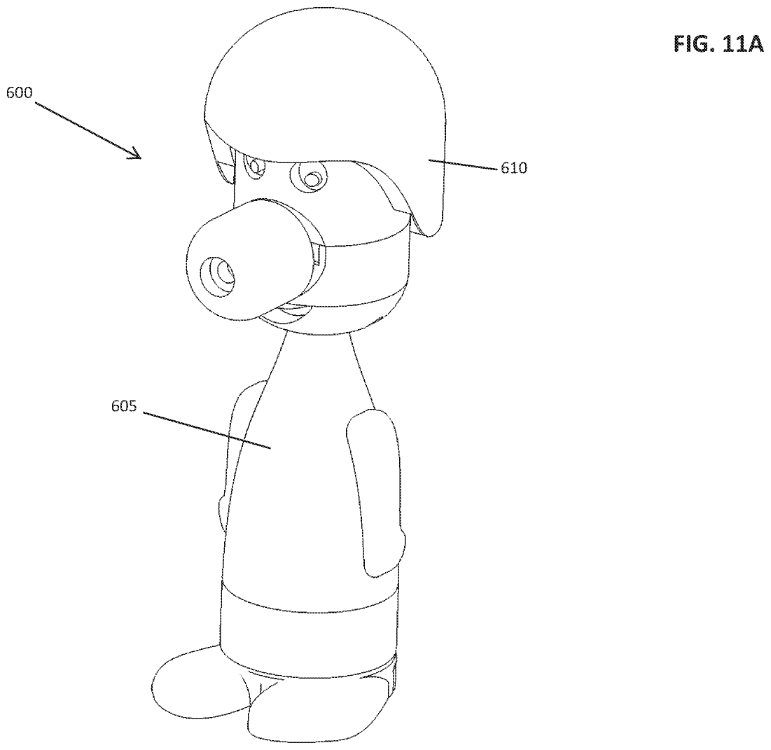

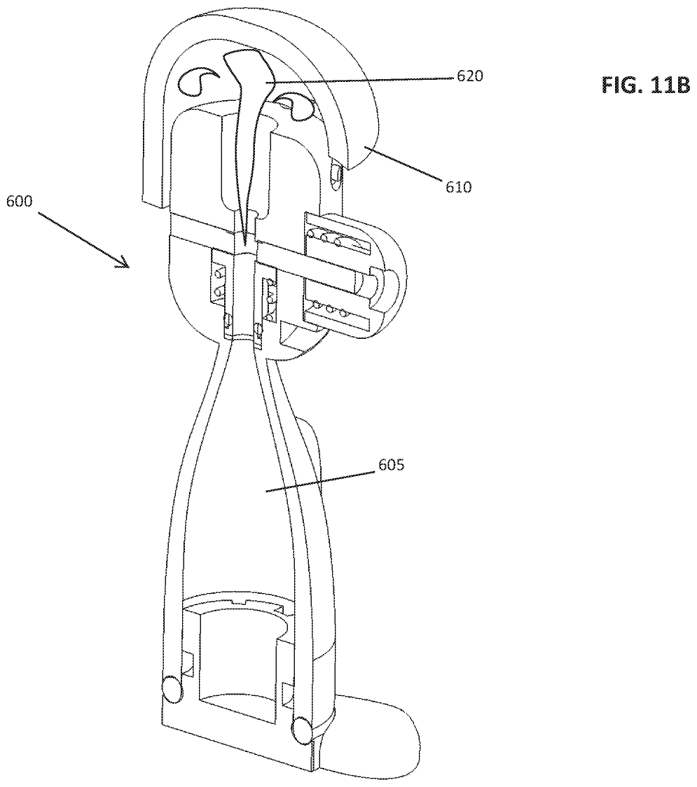

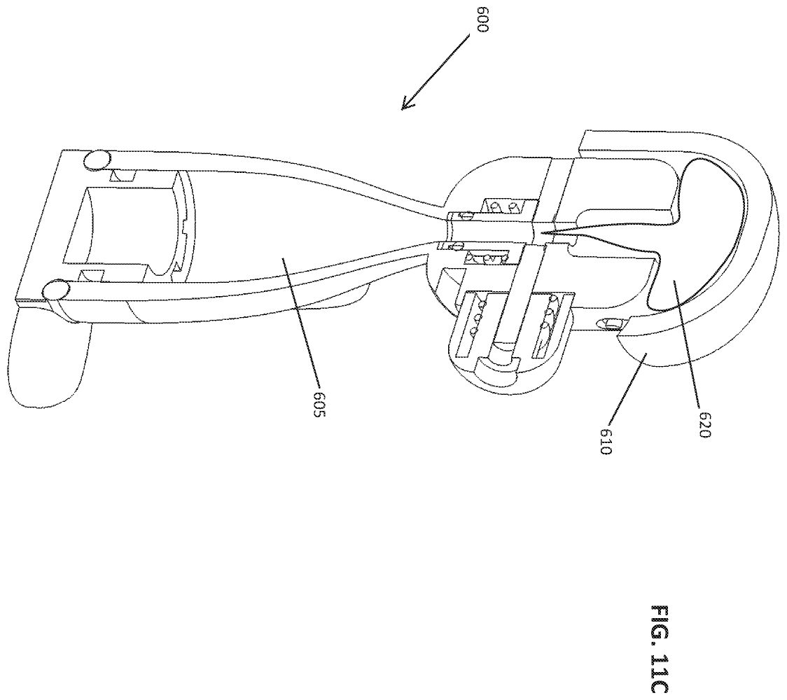

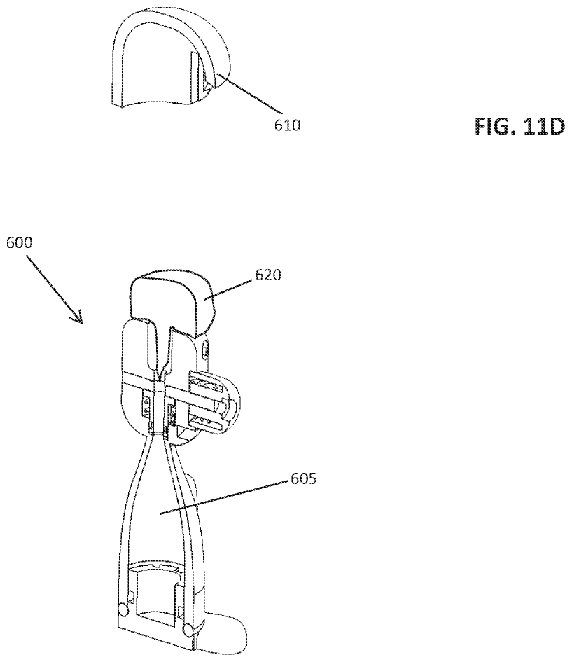

Referring now to FIGS. 11A—11D, there is show a character or figurine 600 that incorporates a rechargeable shooting reservoir 605 as illustrated in its body. The user is able to fill the reservoir 605 as mentioned by the various methods herein. Once filed an outlet can be positioned at various locations to provide various effects. For example, one or more outlets can allow the pressurized foam 620 to expel through the eyes, ears, nose, or under a removeable hat 610. This could add to the enjoyment as it could expel foam which when hardens molds to designs or groves on the inside surface of the hat, to provide for various hair designs.

With further reference to the Figures various embodiments are illustrated herein to show an engagement facilitating charging of a receptacle reservoir cavity from a canister supply of pressurized aerosol foam. The charging of the shooter receptacle reservoir provides a novel concept to take pressurized foam from an existing/purchased canister supply and transfer the foam into a new container with the transfer of the pressure as well. This eliminates the need to include a means for pressurizing the foam once transferred into the receptacle reservoir. The new receptacle container can then fire or shoot the foam under pressure. The foam is pressurized by the chemical compound in the fluid itself. In the embodiments, when the foam is transferred, there is a loss of pressure in the second container, however there is enough pressure to still shoot it out when the second canister is opened with the various actuators as discussed further herein. The operable concept thus includes transferring the foam from one canister to another to then be used later, transferring both the foam and the pressure.

As important aspect of the pressurized foam is that when exposed to open air the pressure in the can forces liquid through the nozzle where the plastic immediately forms a tube with liquid still in its center and that pressurized liquid propagates the string as long as the nozzle is open. Eventually all of the solvent/propellant evaporates, and the plastic starts to dry out. The propellant wants to be a gas at atmospheric pressure and will only remain liquid while it is under adequate pressure in the can. When in use, as the level of propellant drops in the can, the pressure does not change much until the can is nearly empty as long as the temperature is constant. As such, the methods utilized herein allow for the reservoirs to be refilled and reused.

The product or mounted accessory is applicable in a variety of toy products, including but not limited to dolls, figures, toy vehicles, roleplay items, and other toy type items.

The toys for generating a foam string discharge of the present inventions may be embodied as different toy products in a wide variety of shapes, sizes and components. It is to be understood that the embodiments of the invention herein described are merely illustrative of the application of the principles of the invention. From the foregoing, it can be seen that there has been provided a detailed description with various features, and while a particular embodiment of the present invention has been shown and described in detail, it will be obvious to those skilled in the art that changes, and modifications may be made without departing from the invention in its broader aspects. Therefore, the aim is to cover all such changes and modifications as fall within the true spirit and scope of the invention. The matters set forth in the foregoing description and accompanying drawings are offered by way of illustrations only and not as limitations. The actual scope of the invention is to be defined by the subsequent claims when viewed in their proper perspective based on the prior art.

We claim:

1. A toy for generating a foam string discharge having a rechargeable shooting reservoir, wherein the rechargeable shooting reservoir comprising:
a housing member having an internal container for storing a refillable supply of pressurized or aerosol foam;
a port defined on a front portion of the housing member, the port being in fluid communication with a channel into the internal container, and the port configured to receive a supply of pressurized or aerosol foam and configured to discharge pressurized or aerosol foam contained in the internal container;
a valve mechanism on the front portion of the housing member and configured between the port and the channel, the valve mechanism being biased in a closed configuration and having a manual activation button, which when pressed, moves the valve mechanism from the closed configuration to an open configuration, and
wherein when in the closed configuration, the valve mechanism is configured to seal the port from the channel to prevent the discharge of pressurized or aerosol foam in the internal container, and when in the open configuration, the valve mechanism is configured to permit a supply of pressurized or aerosol foam to enter the channel through the port and fill the internal container, and further permit discharge of the pressurized or aerosol foam to create foam string, when the internal container is filled with a pressurized or aerosol foam.

2. The toy of claim 1, wherein the valve mechanism includes:
a gate member position between the port and channel, the gate member having an aperture configured to align with the port and channel when the valve mechanism is in the open configuration, and wherein the gate member is configured to seal the port from the channel when the valve mechanism is in the closed configuration;
a first spring connecting the manual activation button to the gate member and configured to bias the gate member in the closed configuration; and
a stem seal positioned in the channel against the gate member to further seal the channel when the gate member is in the closed configuration.

3. The toy of claim 1 further comprising:
an end cap secured to a back portion of the housing member, and wherein the end cap is removably secured to the back portion by cooperative threading provided on the end cap and back portion of the housing member, such that the end cap is configured to be removed to clean the interior of the housing member.

4. The toy of claim 1, wherein the Internal container has a neck portion adjacent the channel that tapers outwardly to a wider body portion to prevent clogging or malfunction in the channel.

5. The toy of claim 1, wherein the reservoir is embedded into an appendage on a character toy.

6. The toy of claim 1 further comprising a clip configured to secure the reservoir to a toy.

7. A toy for generating a foam string discharge, wherein the toy has a rechargeable shooting reservoir for use with a canister of pressurized foam string, and wherein the canister includes a tip for discharging the pressurized foam activated upon pressing on the tip, wherein the rechargeable shooting reservoir comprising:
a cylinder having an internal container for storing a refillable supply of pressurized foam, the cylinder having an inlet end in fluid communication with the internal container and configured to receive a pressurized foam, and the cylinder further having an exit end in fluid communication with the internal container and configured to discharge pressurized foam contained within the internal container;
an inlet cap secured to the inlet end, the inlet cap having an inlet channel in fluid communication with the Internal container, and the inlet cap further having an inlet one-way valve configured to allow filling of the internal container with pressurized foam from the canister and further configured to seal the inlet channel when the internal container is filled with pressurized foam;
a base end positioned at the exit end and having a base aperture in fluid communication with the internal cylinder,
a rotatable exit cap attached to the exit end, the exit cap having an exit aperture, the exit cap configured to rotate to align the exit aperture with the base aperture to discharge pressurized foam filled in the internal container.

8. The toy of claim 7, wherein the inlet cap removably secured to the inlet end portion by providing a pair of diametrically opposed groove locks on the inlet end and a pair of corresponding pins extending outwardly from the inlet cap and which are positioned to engage the groove lock.

9. The toy of claim 7 further comprising a rigid flange member positioned near the flexible flange member, such that the rigid flange member is configured to prevent excessive movement of the flexible flange member when the internal container is filled with a supply of pressurized or aerosol foam.

10. The toy of claim 7 further comprising an O-ring around a portion of the inlet cap to seal the inlet cap against a portion of the internal container.

11. The toy of claim 7, wherein the inlet one-way valve is defined by having a flexible flange member positioned over the inlet channel and configured to seal the Inlet channel from the internal container, when the pressurized foam in the internal container applies a pressure force against the flexible flange member, the flexible flange member further configure to bend into the internal container when pressurized foam is injected into the channel to fill the internal container with the pressurized foam.

12. The toy of claim 7, wherein the exit cap has a handle configured for manual manipulation.

13. The toy of claim 7, wherein the exit cap further includes an arcuate recess sized to receive a projection pin extending from the base end, and wherein the arcuate recess controls the rotation of the rotatably exit cap.

14. A toy for generating a foam string discharge, wherein the toy has a rechargeable shooting reservoir for use with a canister of pressurized foam string, and wherein the canister includes a tip for discharging the pressurized foam activated upon pressing on the tip, wherein the rechargeable shooting reservoir comprising:
a cylinder having an internal container for storing a refillable supply of pressurized foam, the internal container having a bottom end, a front end, and at least one discharge port positioned towards the front end;
a removable end cap attached to the bottom end;
a free-floating piston positioned within the internal container, the piston having a piston base with an outer perimeter sized to rest against a surface wall defined by the internal container, the piston further having a piston rod extending from the piston base towards the front end, and the piston further having a bore extending therethrough to define a fluid channel from an inlet defined in the piston rod to an aperture in the piston base, and the piston further having a one-way valve attached over the aperture in the piston base such that pressurized foam may travel only into the internal container by the inlet;
a top rotatably attached to the front end, the top having an aperture configured to align with the piston rod when the top is rotated to an open configuration; and
the free-floating piston being positioned towards the bottom end when the top is in a closed configuration, such that the piston base separates the internal container with pressurized foam from the at least one discharge port further causing the pressurized foam to press against the piston base towards the front end, and wherein
when the top is rotated to the open configuration, the aperture aligns with the piston rod allowing the pressurized foam to move the piston towards the front end such that the at least one discharge port is exposed to the internal container with pressurized foam, whereby the pressurized foam ejects out of the at least one discharge port.

15. The toy of claim 14, wherein the top includes slots, each slot being sized to receive a fastener secured to the front end such that the top rotates as the fasteners slide in the slots.

16. The toy of claim 14 further comprising a compression spring fitted into a recess defined in the front end and the top and configured to bias the top in a closed configuration.

17. The toy of claim 14, wherein the end cap further includes a wiper extending from the end cap into the internal container, the wiper further has a wiper edge extending along a portion of a surface wall defined by the internal container, such that when the removably end cap is removed, the wiper edge cleans the internal container by scraping the surface wall.

18. A cap adapter for a canister of pressurized foam string, wherein the canister includes a tip for discharging the pressurized foam and the cap adapter being used with a rechargeable shooting reservoir, the cap adapter further comprising:
a head portion fitted over the top of the canister, the head portion having an opening to expose the tip of the canister; and
channels defined in head portion adjacent the opening, the channels defined to receive guide pins defined on the rechargeable shooting reservoir such that the tip of the canister inserts into an inlet port defined on the rechargeable shooting reservoir, and
wherein the canister discharges pressurized foam into the rechargeable shooting reservoir when it is attached to the head portion of the cap adapter.

19. The cap adapter of claim 18 further comprising:
a movable tab defined along the head portion adjacent the opening and configured to press against a valve button defined on the rechargeable shooting reservoir to permit the filling of the rechargeable shooting reservoir with pressurized foam from the canister.

20. The cap adapter of claim 18 further comprising:
a tapered edge defined along a section of the head portion adjacent the opening, the tapered edge configured to press against a valve button defined on the rechargeable shooting reservoir when the rechargeable shooting reservoir is pressed downwardly onto the cap adapter thereby permitting the filling of the rechargeable shooting reservoir with pressurized foam from the canister.

21. The cap adapter of claim 18, wherein
the channels are angled along with opening of the head portion and the head portion includes a tapered edge defined along a section of the head portion adjacent the opening, the tapered edge configure to press against a valve button defined on the rechargeable shooting reservoir when the rechargeable shooting reservoir is inserted into the head portion and twisted towards the tapered edge, thereby permitting the filling of the rechargeable shooting reservoir with pressurized foam from the canister.

22. A toy for generating a foam string discharge, wherein the toy has a rechargeable shooting reservoir for use with a canister of pressurized foam string, and wherein the canister includes a tip for discharging the pressurized foam activated upon pressing on the tip, wherein the rechargeable shooting reservoir comprising:
a cylinder having an internal container for storing a refillable supply of pressurized foam, the internal container having a bottom end, and a front end;
a removable end cap attached to the bottom end;
a free-floating piston positioned within the internal container, the piston having a piston base with an outer perimeter sized to rest against a surface wall defined by the internal container, the piston further having a piston rod extending from the piston base towards the front end, and the piston further having a bore extending therethrough to define a fluid channel from a port defined in the piston rod to an aperture in the piston base;
a top rotatably attached to the front end, the top having a port aperture configured to align with the piston rod when the top is rotated to an open configuration for filling the internal container with pressurized foam; and
the free-floating piston being positioned towards the bottom end when the top is in a closed configuration, such that the aperture in the piston base seals against a tip attached to the end cap causing the pressurized foam to press against the piston base towards the front end, and wherein
when the top is rotated to the open configuration, the port aperture aligns with the piston rod allowing the pressurized foam to move the piston towards the front end such that pressurized foam ejects through the piston base aperture and out port aperture.

23. The toy of claim 22, wherein the end cap further includes a wiper extending from the end cap into the internal container, the wiper further has a wiper edge extending along a portion of a surface wall defined by the internal container, such that when the removably end cap is removed, the wiper edge cleans the internal container by scraping the surface wall.
